(19) United States
(12) Patent Application Publication
(10) Pub. No.: US 2003/0110102 A1
(43) Pub. Date: Jun. 12, 2003

(54) Method for goods arrangement and its system

(75) Inventors: Chen-Fu Chien, Hsinchu City (TW); Jing-Feng Deng, Hsinchu City (TW)

Correspondence Address: Ladas & Parry, 26 West 61 Street, New York, NY, 10023, US

(73) Assignee: CHEN-FU CHIEN

(21) Appl. No.: 09/866,858

(22) Filed: May 29, 2001

(51) Int. Cl. G06F 17/60

(52) U.S. Cl. 705/28

(57) ABSTRACT

The present invention discloses a method for goods arrangement and its system for placing the goods into a storage space (such as container, a box car, a cargo bay of a plane, a cargo ship, a goods shelf of a storehouse and pallet). The arrangement method of the present invention makes fully use of the storage space by representing the space in spatial representation and considering all kinds of factories of the goods and the storage space. Furthermore, the method of the present invention can also computes the loading and unloading priority of the goods, the location of the goods, the total weight of the storage space and the space utilization rate. The present invention also combines a heuristic algorithm and a drawing interface for developing a system for goods arrangement to improve the space utilization rate.

### BACKGROUND OF THE INVENTION

1. Field of the Invention

The present invention relates to a method for goods arrangement and its system, and more particularly, to a method for goods arrangement and its system combining a heuristic algorithm to make fully use of a available space of a storage space.

2. Description of the Prior Art

Due to rapid development of the industry, there is a need for more space and more time for goods storage or transportation. For densely populated countries, how to decrease space for accommodating the goods and improve goods transportation time are factors for lowering the goods cost.

At present, due to frequent international trade, the transportation cost will increase the cost for running an enterprise, no matter whether the goods is transported by air or by sea. Especially, for island countries, transportation efficiency and quality are related to the economical and the trading developments of the countries and their overall competitiveness.

The key point of the transportation is how to improve the utilization rate of a storage space and shorten the loading and unloading time of the goods.

For the container transportation method of goods arrangement, a conventional arrangement process is to calculate the weight and the size of the goods after the goods arrives at a transportation center. Then, the goods will be classified by experienced workers according to destinations, customer's requirements and the properties of the goods. Finally, the workers arrange the goods in the container according to the properties (such as fragility or prohibition of inclination). The container arranging work is not only complicated but also needs a lot of manpower. Usually the goods allocation and arrangement will spend a lot of time. Sometimes, the worker will take out the goods, which had been placed in the container, from the container in order to place more goods. Therefore, a lot of manpower and time will be wasted.

However, since the cost of the manpower is increased, the conventional transportation service is losing their competitiveness gradually. Therefore, in order to improve the container transportability and efficiency and decrease the transportation cost, how to guide the conventional transportation service to information, profession and automation is an important task for the present transportation service.

Problems with the conventional method of the goods arrangement can be classified as follow:

1. Loading Problem:

The loading problem is also called Knapsack problem. The problem resides in studying how to pack the different size and different weight goods into a package to maximize the package utilization rate and minimize the space wasteness. An one-dimension and the two-dimension loading problems are the common problems with the loading problem. The two-dimension loading problem deals with how to place smaller rectangles into a larger rectangle of fixed lengths and widths. In 1990, Gehing et. al. taught a goods arrangement method for packing the goods in only one container by considering both the goods weight and the goods size and pointed out the goods location in the container with a spatial representation by the computer. In 1990, Bischoff and Marriott taught an arrangement method for packing the goods in a plurality of containers by considering the weight of the goods and arranging the goods with a heuristic concept.

2. Stock Cutting Problem:

The stock cutting problem is also called packing problem. A two-dimension rectangular packing problem, which is similar to the above loading problem, deals with cutting a rectangle of a fixed length and width into several smaller rectangles of different sizes. The same purpose of the two-dimension packing problem and the above loading problem is to minimize the space wasteness. However, a different point is that the loading problem deals with placing a small rectangle into a large rectangle, and the two-dimension rectangular packing problem deals with the small rectangles, which are produced by cutting a large rectangle.

3. Bin-Packing Problem

The bin packing problem deals with studying related problems caused by minimizing the memory space of the computer. The goods of this problem need to be load into a large rectangle and stay close to the edge of the rectangle. Moreover, the goods of this problem, are arranged in a fixed orientation and in a minimum height.

4. Pallet Loading Problem

The pallet loading problem deals with arranging the goods of the same size into a prescribed rectangle or pallet. The height of the stacked goods is unrestricted, but the gravity center of the container has to be considered. Thus, this problem is similar to the two-dimension rectangular packing problem.

The above studies emphasize arranging goods in a plurality of spaces but not describing how to improve the utilization rate of the storage space. Therefore, it is necessary to provide a high efficiency arrangement method for the industrial circles at present.

### SUMMARY OF THE INVENTION

A first object of the present invention is to provide an arrangement method for improving the space utilization rate and decreasing the transportation cost.

A second object of the present invention is to provide an arrangement method for shortening the loading and unloading time of the goods.

A third object of the present invention is to provide an arrangement system for computing and showing the loading pattern of the goods automatically and indicating the coordinate location of the goods in a storage space.

A fourth object of the present invention is to provide an arrangement system with a client-server model.

To achieve the above-mentioned objects, the storage space of the present invention (such as a container, a box car, a cargo bay of a plane, a cargo ship, goods shelves of a storehouse and pallet), is cut in three-dimension model and considering all kinds of factors of the goods and the storage space, such as the shape, size, amount and weight of the goods, the gravity center of the storage space and the destination of the goods. Furthermore, arrangement of the goods in different models is also studied.

Moreover, the present invention discloses a spatial representation and a heuristic method for computing the loading pattern, the unloading pattern, the location of the goods, the total goods weight in the storage space and the space utilization rate. The present invention also discloses an arrangement method in combination with a valuation and quotation model for computing the transportation cost and the expenses of each batch of goods. The heuristic algorithm is to rank the goods in an order and arrange suitable goods into suitable locations of the storage space. The heuristic algorithm comprises: (1) selecting the goods of a next order according to a ranking rule if the size of an available space is smaller than the size of a selected goods; (2) rotating the bottom of the goods for obtaining an optimal orientation; (3) placing the selected goods upright; (4) stacking the selected goods to form a vertical column; and (5) combining a plurality of vertical columns to form a lateral wall or a longitudinal wall. The coordinate of the first selected goods computed by a heuristic method can be represented by a spatial representation. Then, the location of the second selected goods is obtained by computing a matrix operation program (such as Matlab) and the others are obtained in a similar manner. Finally, the operation result will be output to an output device such as a personal computer or a personal digital assistant (PDA), etc. Therefore, the manager or the worker can arrange the goods according to the output operation result.

The output device of the present invention can be further combined with a Graphic User Interface (GUI) for displaying the arranging pattern in three-dimension. Thus, the worker or the manager can observe the arranging pattern from various viewing angles for understanding the goods arrangement more deeply.

The foregoing and other objects and advantages of the invention and the manner in which the same are accomplished will become clearer based on the following detailed description taken in conjunction with the accompanying drawings.

### BRIEF DESCRIPTION OF THE DRAWINGS

FIG. 1 depicts a flow chart of the goods arrangement method of the present invention;

FIG. 2 depicts another flow chart of the goods arrangement method of the present invention;

FIG. 3 depicts a divided spatial representation of the present invention;

FIG. 4(a) depicts a diagram for building a longitudinal wall according to the method of the present invention;

FIG. 4(b) depicts a diagram for building a lateral wall according to the method of the present invention;

FIG. 5 depicts a function block diagram of each module of the present invention;

FIG. 6 depicts a connection diagram of the arrangement system of the present invention;

FIG. 7 depicts a three-dimension perspective view of one embodiment of the present invention for placing a first goods;

FIG. 8 depicts a three-dimension perspective view of one embodiment of the present invention for placing a second goods;

FIG. 9 depicts a three-dimension perspective view of one embodiment of the present invention for placing a fifth goods;

FIG. 10 depicts a three-dimension perspective view of one embodiment of the present invention for placing a tenth goods;

FIG. 11 depicts a three-dimension perspective view of one embodiment of the present invention;

FIG. 12 depicts a three-dimension perspective view of one embodiment of the present invention in another viewpoint;

FIG. 13 depicts a three-dimension perspective view of a first storage space of another embodiment of the present invention;

FIG. 14 depicts a three-dimension perspective view of a second storage space of another embodiment of the present invention;

FIG. 15 depicts a three-dimension perspective view of a third storage space of another embodiment of the present invention;

FIG. 16 depicts a three-dimension perspective view of a fourth storage space of another embodiment of the present invention; and

FIG. 17 depicts a three-dimension perspective view of a fifth storage space of another embodiment of the present invention.

### DETAILED DESCRIPTION OF THE INVENTION

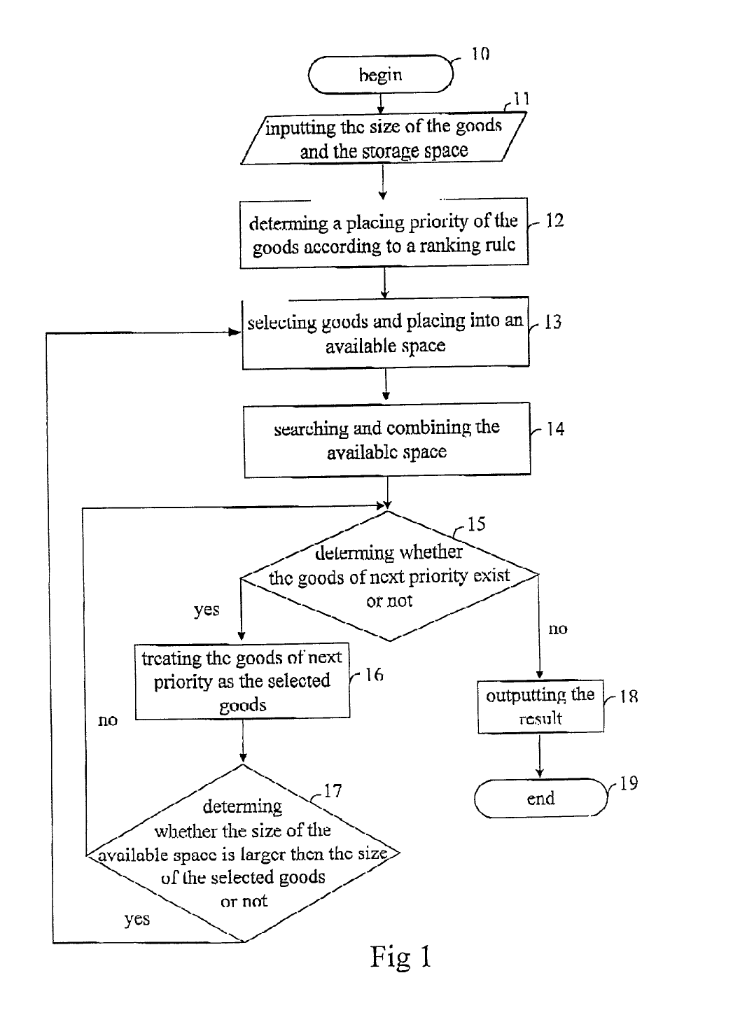

FIG. 1 depicts a flow chart of the present invention. In step 10, it is the beginning of the flow chart of the present invention. In step 11, the related information of the goods, which should be placed into a storage space, and the storage space are input into a computer (such as the factors of the size or the weight). The storage space comprises a container, a box car, a cargo bay of a plane, a cargo ship, a goods shelf of a storehouse and pallet, etc. The goods are allocated according to its destination; and the goods with same route will be disposed into the same cargo pool. The goods arrangement method of the present invention is to arrange the goods in the same cargo pool. In step 12, a placing priority of the goods is determined in accordance with a ranking rule; and the goods with the first priority is selected for placing into the storage space. In step 13, the above selected goods are placed into an available space according to a heuristic algorithm and the coordinate of the selected goods is marked in the storage space with a spatial representation. In step 14, available spaces of the storage space are searched for and then combined combined. The size of the available space of the storage space of the present invention is represented by the above-mentioned spatial representation. If the storage space is empty, the whole storage space will be treated as a complete space. However, if there is several goods in the storage space already, the storage space will be divided into a plurality of fragmentary sections. Thus, in order to place the goods efficiently in the storage space, the plurality of fragmentary sections have to be combined into several larger available spaces. In step 15, whether the goods with the next priority exist or not is determined, and if it is affirmative, the step 16 is proceeded with; otherwise, the step 18 is proceeded with. In step 16, the goods with the next priority is treated as a selected goods at the moment. In step 17, whether the available space of the storage space at the moment is larger than the size of the selected goods or not is determined, and if it is affirmative, the step 13 is proceeded with; otherwise, the step 15 is proceeded with. In step 18, the goods is arranged and the arrangement result is output to a personal computer or a personal digital assistant (PDA) etc. In step 19, the flow chart of the present invention ends.

The goods of the present invention is stacked according to a wall building theorem. That is, in step 12, when the goods is placed according to the ranking rule, the goods with a larger base will be placed in the bottom layer of the storage space to stabilize the base of the stacked goods. The ranking rule comprises:

rank 1: selecting the goods with the highest cost effective benefit;

rank 2: selecting the goods with the largest base dimensions (the largest length or the largest width); and

rank 3: selecting the goods with the largest base area.

The highest cost effective of the goods is obtained by dividing the transportation cost of the goods by the weight or the volume of the goods. Moreover, the ranking rule further comprises:

rank 4. selecting the goods with the maximal density (weight/volume);

rank 5. selecting the goods with the maximal length;

rank 6. selecting the goods with the maximal width; and

rank 7. selecting the goods with the maximal height.

The arrangement of goods needs to be performed in the order from rank 1 to rank 3; however, whether the goods can be arranged according to the rank 4 to rank 7 depends on the status of the goods arrangement.

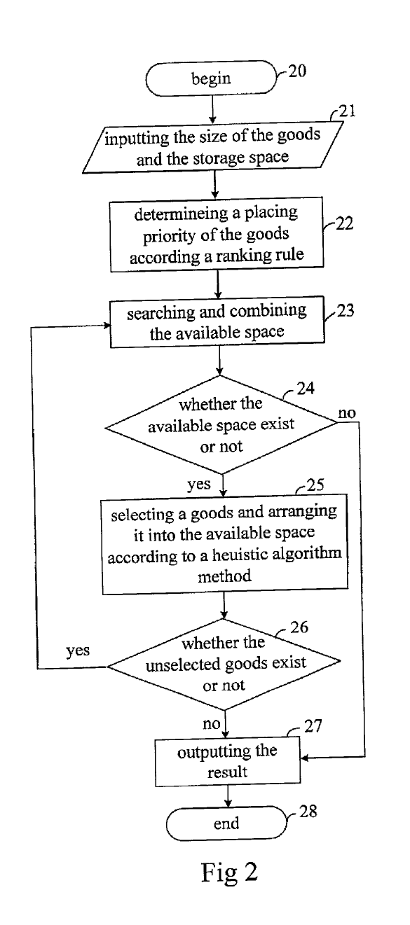

FIG. 2 depicts another flow chart of the present invention. In step 20, it is the beginning of the flow chart of the present invention. In step 21, the related information of the goods, which should be placed into a storage space, and the storage space are input into a computer (such as the factors of the size or the weight). In step 22, a placing priority of the goods is determined in accordance with a ranking rule. In step 23, available spaces of the storage space are searched for and combined. In step 24, whether the available space in the storage space exist or not is determined, and if it is affirmative, the step 25 is proceeded with; otherwise, the step 27 is proceeded with. In step 25, an applicable goods is selected according to the heuristic algorithm and placed into an available space. In step 26, whether an unselected goods exist or not is determined and if it is affirmative, the step 23 is proceeded with; otherwise, the step 27 is proceeded with. In step 27, the arrangement is stopped and the result is output to a personal computer or a personal digital assistant (PDA) etc. In step 28, the flow chart of the invention ends.

In FIG. 2, the steps 20 to 22 of the flow chart are treated as an initial input phase. The steps 23 and 24 are treated as a space search phase. The steps 25 and 26 are treated as a goods loading phase. The steps 27 and 28 are treated as a result output phase. In addition, the above heuristic algorithm comprises the following steps:

1. selecting the goods of next priority in accordance with the above ranking rule if the size of the available space is smaller than the size of the selected goods;

2. rotating the base of the goods to the right side or to the left side to determine the optimal orientation when placing the goods into the storage space;

3. keeping the goods upright if the goods is fragile;

4. building a vertical column when placing the goods into the storage space; and

5. combining vertical columns to build a lateral wall or a longitudinal wall.

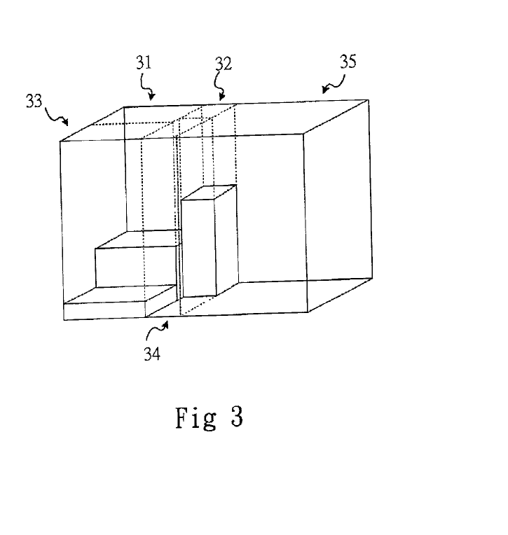

FIG. 3 depicts the divided spatial representation of the present invention for an example of the storage space with three goods. In this example, the storage space will be divided into a plurality of fragmentary sections. However, to accommodate more goods, the plurality of fragmentary sections are combined into five more complete spaces 31-35.

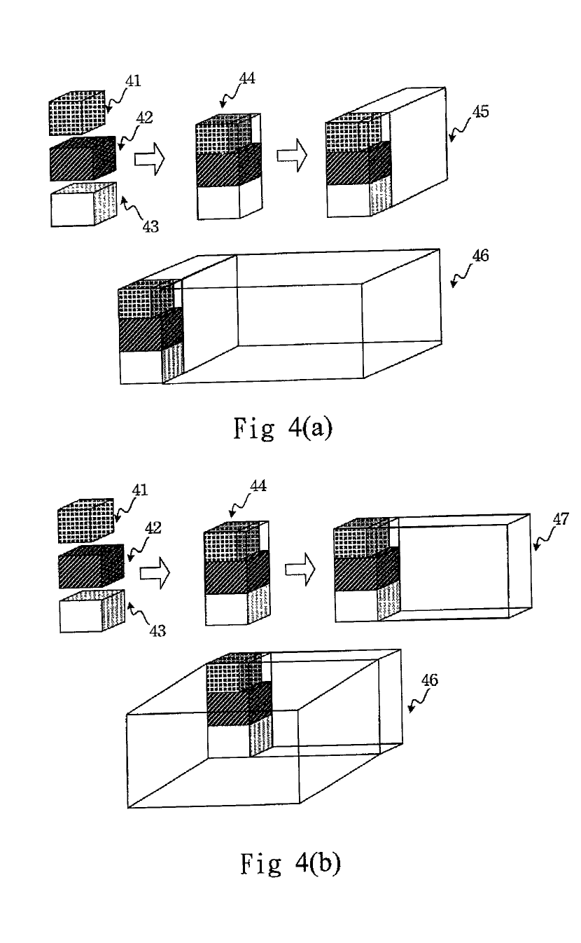

FIGS. 4(a) and 4(b) depict diagrams of a lateral wall and a longitudinal wall respectively built according to the above space combining method to provide two different kinds of loading patterns. In FIG. 4(a), the goods 41, 42 and 43 selected according to the ranking rule are stacked to form a vertical column 44. If the size or the height of the available space on top of the vertical column 44 is smaller than that of selected goods, the goods will be placed in the space adjacent to the vertical column and another vertical column is formed. The adjacent vertical columns are combined to form a longitudinal wall 45 and then placed into a storage spaced 46. In FIG. 4(b), the adjacent vertical columns are combined to form a lateral wall 47 and then placed into the storage space 46 (such as a container, a box car, a cargo bay of a plane, a cargo ship, a goods shelf of a storehouse and the pallet). However, whether the loading pattern of the longitudinal wall 47 or the lateral wall 45 is adopted depending on the setting of the heuristic algorithm. If the size of the selected goods is smaller than the available space on the longitudinal wall 47 or the lateral wall 45 or if the longitudinal wall 47 or the lateral wall 45 has been filled, the selected goods will be placed into the space adjacent to the wall, and another longitudinal wall or another lateral wall is built. The above steps will be performed until the available space of the storage space is smaller than the size of unselected goods or until all goods have been placed into the storage space. The present invention further considers the weight, the placing priority and the other characteristic of the goods (such as fragility). Moreover, the goods in the same vertical column can be interchanged to meet the placement requirement; or the longitudinal wall or the lateral wall can be interchanged to balance the center of the gravity of the storage space.

In the conventional multistage division researches, the goods loaded across the boundary between the adjacent walls is unallowable. Therefore, the space wasteness is unavoidable when loading different shape or different size goods into the storage space without across the boundary between the adjacent walls. The present invention discloses an arrangement method considering the gravity center of the storage space and combining the available space to solve the above problems of the prior art.

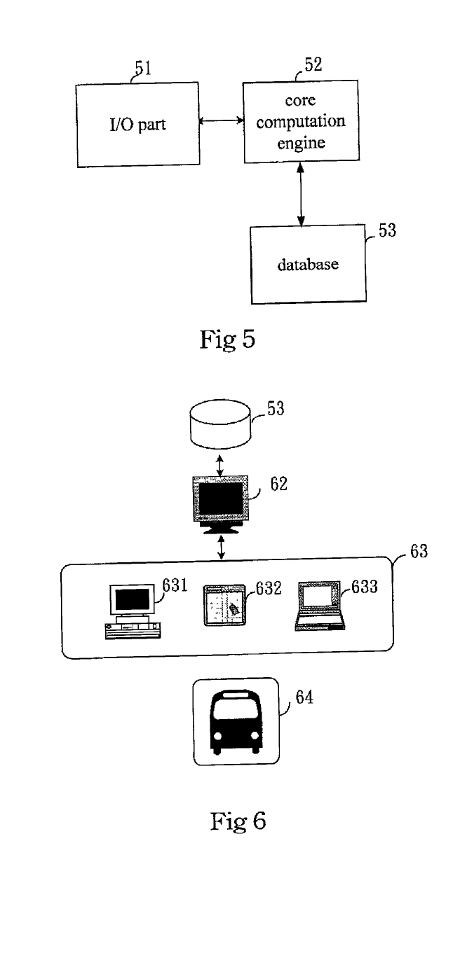

FIG. 5 depicts a function block diagram of each module of the present invention. The module comprises an I/O (input and output) mechanism 51, a core computation engine 52 and a database 53. The I/O mechanism 51 design a Graphic User Interface (GUI) by an Excel VBA for allowing the user to input the information of the storage and the goods, which should be loaded into the storage space, and a drawing interface to demonstrate the loading pattern of the goods. For example, the drawing interface demonstrates the result of the loading pattern, ranking by the heuristic algorithm, with a three-dimension graphic demonstration in different viewpoints. The core computation engine 52 is the key point of the present invention for computing the priority of the goods by the heuristic algorithm and calculating the location, orientation and the spatial representation of the goods by a matrix operation program, such as Matlab. The database 53 is used for storing the information of the storage space and the goods such as the volume and the weight.

FIG. 6 depicts the connection circuit diagram of the goods arrangement system of the present invention. The system comprises a database 53, a workstation 62, a terminal 63 and a storage space 64 (a box car or a container shown in diagram). The system of the present invention is base on a client-server model. An upstream user inputs related information of the goods (such as the size, weight, destination and the time) into the client-server model database 53. The workstation 62 that is the core computation engine 52 is used for reading the information in the database 53 and calculating a pressmark of the storage space, which the goods should be placed (the pressmark of the box car or the container in this embodiment), the goods location in the storage space and the placing priority of the goods. The workstation 62 is connected in wired or wireless manner with the terminal 63 (such as a computer 631, a personal digital assistant 632, a notebook computer 633 or a cellular phone etc.), so that a downstream user can obtain the priority, the location and the orientation of the goods from the terminal 63.

The present invention considers not only the size and the weight of the goods but also the balance of the storage space and the loading and unloading priority to decrease the transportation cost and improves the operation efficiency.

### EXAMPLE 1

This example illustrates the arrangement method with a single storage space which is a cargo container. A dry container with 20 feet is selected. The length, the width and the height of the dry container are 590 cm, 230 cm and 240 cm, respectively. The respective spatial representation are shown as follow:

$$[ \begin{matrix}240 & 590 \\ 230 & 0\end{matrix} ]$$

The length and the width of the base, the height and the amount of the goods are shown in Table 1:

TABLE 1

| | | | |
|---|---|---|---|
| base length and | | amount of | |
| base width | height | the goods | pressmark |

| | | | | |
|---|---|---|---|---|
| 50 | 40 | 50 | 10 | 1 |
| 100 | 70 | 40 | 5 | 2 |
| 100 | 70 | 50 | 5 | 3 |
| 80 | 80 | 80 | 3 | 4 |
| 100 | 80 | 100 | 3 | 5 |
| 100 | 100 | 120 | 3 | 6 |
| 100 | 100 | 50 | 2 | 7 |
| 100 | 80 | 50 | 2 | 8 |
| 200 | 100 | 100 | 3 | 9 |
| 200 | 100 | 120 | 4 | 10 |

The goods are arranged in accordance with the ranking rule mentioned above and the results are shown in Table 2.

TABLE 2

| | | | |
|---|---|---|---|
| base length and | | amount of | |
| base width | height | the goods | pressmark |

| | | | | |
|---|---|---|---|---|
| 50 | 40 | 50 | 10 | 1 |
| 80 | 80 | 80 | 3 | 4 |
| 100 | 70 | 40 | 5 | 2 |
| 100 | 70 | 50 | 5 | 3 |
| 100 | 80 | 50 | 2 | 8 |
| 100 | 80 | 100 | 3 | 5 |
| 100 | 100 | 50 | 2 | 7 |
| 100 | 100 | 120 | 3 | 6 |
| 200 | 100 | 100 | 3 | 9 |
| 200 | 100 | 120 | 4 | 10 |

The goods of pressmark 10 in Table 2 is selected to be the first priority goods and loaded in the coordinate origin (0,0,0) of the container. The amount of the goods of pressmark 10 is subtracted by 1 and the spatial representation is updated as follow:

$$[ \begin{matrix}120 & 200 & 590 \\ 100 & - 10 & 0 \\ 230 & 0 & 0\end{matrix} ] [ \begin{matrix}240 & 200 & 590 \\ 100 & 0 & 0 \\ 230 & 0 & 0\end{matrix} ] \\ Z = 0 to 120 Z = 120 to 240$$

The symbol .−10. is to represent the location of the goods of pressmark 10. The space of the container has been divided into several sections, since the goods of pressmark 10 is loaded. Thus, available spaces have to be combined. First, the selected goods is loaded in a space, in which the base points X and Y are the same, for building a vertical column. When the vertical column is filled, then the selected goods is loaded in a space, in which the same base points X and Y are the same, for building a longitudinal wall.

Moreover, the size of the selected goods is compared with the size of the combined space. If the size of the combined space is larger than the size of the selected goods, the selected goods is loaded into the combined space of the container and the spatial representation is updated. If the combined space is smaller than the size of the selected goods, the goods of the next priority will be selected according to Table 2 for loading into the available space. If there is no suitable available space for the goods after comparing every goods with an available space, the procedure will be stopped. Herein, a space whose (length, width, height)=(200, 100, 120) and the base point (x, y, z)=(0, 0, 120) is selected and the spatial representation matrix is updated as follow:

$$[ \begin{matrix}120 & 200 & 590 \\ 100 & - 10 & 0 \\ 230 & 0 & 0\end{matrix} ] [ \begin{matrix}240 & 200 & 590 \\ 100 & 0 & 0 \\ 230 & 0 & 0\end{matrix} ] \\ Z = 0 to 120 Z = 120 to 240$$

Similarly, the size of the selected goods is compared from top to down with the size of the combined available space. If the size of the combined available space is larger than the size of the selected goods, then the selected goods will be loaded into the combined available space of the container and the spatial representation will be updated. If the combined space is smaller than the size of the selected goods, the goods of the next priority will be selected in accordance with Table 2 for loading into the available space. If there is no suitable available space for the selected goods, another space whose (length, width, height)=(200, 130, 340) and the base point (x, y, z)=(0, 100, 0) is selected and the spatial representation matrix is updated as follow:

$$[ \begin{matrix}120 & 200 & 590 \\ 100 & - 10 & 0 \\ 200 & - 10 & 0 \\ 230 & 0 & 0\end{matrix} ] [ \begin{matrix}240 & 200 & 590 \\ 100 & - 10 & 0 \\ 200 & 0 & 0 \\ 230 & 0 & 0\end{matrix} ]$$

The above steps are repeated until all goods have been loaded into the container, and the results are shown in Table 3.

TABLE 3

| | dimension | | | base point | | |
|---|---|---|---|---|---|---|
| pressmark | base dimension | | height | X-axis | Y-axis | Z-axis |
| 10 | 200 | 100 | 120 | 0 | 0 | 0 |
| 10 | 200 | 100 | 120 | 0 | 0 | 120 |
| 10 | 200 | 100 | 120 | 0 | 100 | 0 |
| 10 | 200 | 100 | 120 | 0 | 100 | 120 |
| 9 | 200 | 100 | 100 | 200 | 0 | 0 |
| 9 | 200 | 100 | 100 | 200 | 0 | 100 |
| 9 | 200 | 100 | 100 | 200 | 100 | 0 |
| 6 | 100 | 100 | 120 | 200 | 100 | 100 |
| 6 | 100 | 100 | 120 | 300 | 100 | 100 |
| 6 | 100 | 100 | 120 | 400 | 0 | 0 |
| 7 | 100 | 100 | 50 | 400 | 0 | 120 |
| 7 | 100 | 100 | 50 | 400 | 0 | 170 |
| 5 | 100 | 80 | 100 | 400 | 100 | 0 |
| 5 | 100 | 80 | 100 | 400 | 100 | 100 |
| 5 | 80 | 100 | 100 | 500 | 0 | 0 |
| 8 | 80 | 100 | 50 | 500 | 0 | 100 |
| 8 | 80 | 100 | 50 | 500 | 0 | 150 |
| 3 | 70 | 100 | 50 | 500 | 100 | 0 |
| 3 | 70 | 100 | 50 | 500 | 100 | 50 |
| 3 | 70 | 100 | 50 | 500 | 100 | 100 |
| 3 | 70 | 100 | 50 | 500 | 100 | 150 |
| 2 | 100 | 70 | 40 | 200 | 0 | 200 |
| 2 | 100 | 70 | 40 | 300 | 0 | 200 |
| 2 | 100 | 70 | 40 | 400 | 100 | 200 |
| 2 | 70 | 100 | 40 | 500 | 0 | 200 |
| 2 | 70 | 100 | 40 | 500 | 100 | 200 |
| 1 | 50 | 40 | 50 | 400 | 180 | 0 |
| 1 | 50 | 40 | 50 | 400 | 180 | 50 |
| 1 | 50 | 40 | 50 | 400 | 180 | 100 |
| 1 | 50 | 40 | 50 | 400 | 180 | 150 |
| 1 | 50 | 40 | 50 | 450 | 180 | 0 |
| 1 | 50 | 40 | 50 | 450 | 180 | 50 |
| 1 | 50 | 40 | 50 | 450 | 180 | 100 |
| 1 | 50 | 40 | 50 | 450 | 180 | 150 |

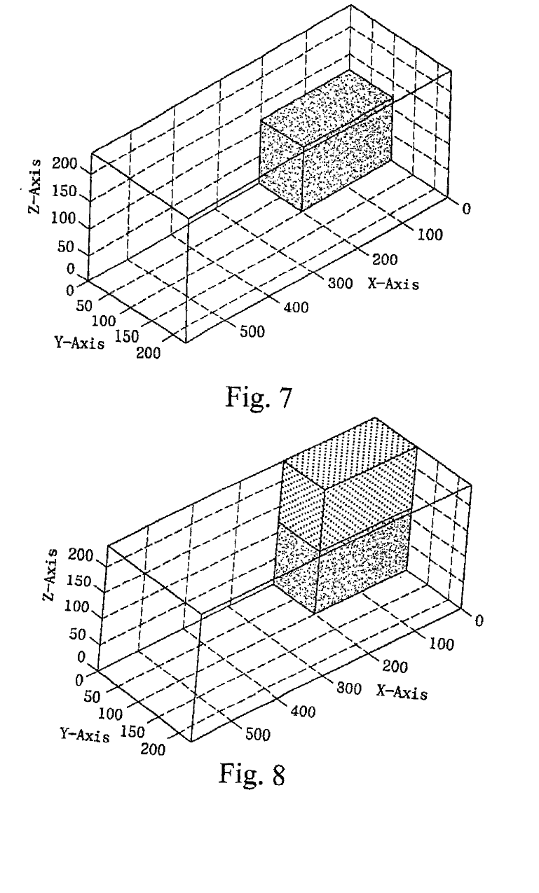

FIGS. 7 to 12 illustrates the three-dimensional perspective view of the preferred embodiment of the present invention. The terminal 63 of the present invention is applied for displaying the loading pattern of the goods at the moment. Moreover, the loading pattern can be displayed in three-dimension to reinforce the user's understanding.

FIG. 7 depicts a perspective view of the embodiment of the present invention for loading the first priority goods. The first priority goods, which the pressmark is 10, is loaded into the location with the base point (x, y, z)=(0, 0, 0).

FIG. 8 depicts a perspective view of the embodiment of the present invention for loading the second priority goods. The second priority goods, which the pressmark is 10, is loaded into the location with the base point (x, y, z)=(0, 0, 120).

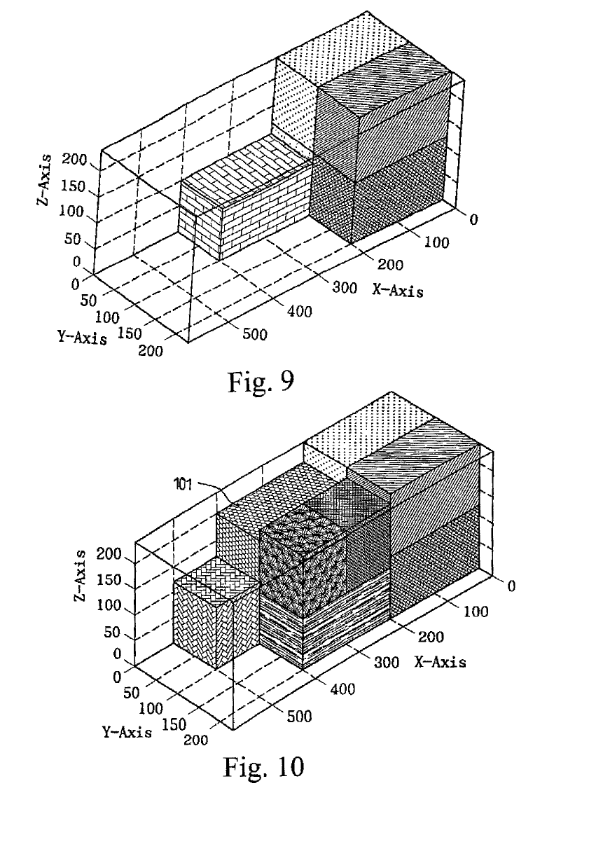

FIG. 9 depicts a perspective view of the embodiment of the present invention for loading the fifth priority goods. In FIG. 9, four goods with pressmark 10 have been stacked up for building a longitudinal wall.

FIG. 10 depicts a perspective view of the embodiment of the present invention for loading the tenth priority goods. In FIG. 10, two longitudinal walls have been built, and there still has an available space with the height of 40 cm on top of the goods 101, which pressmark is 9.

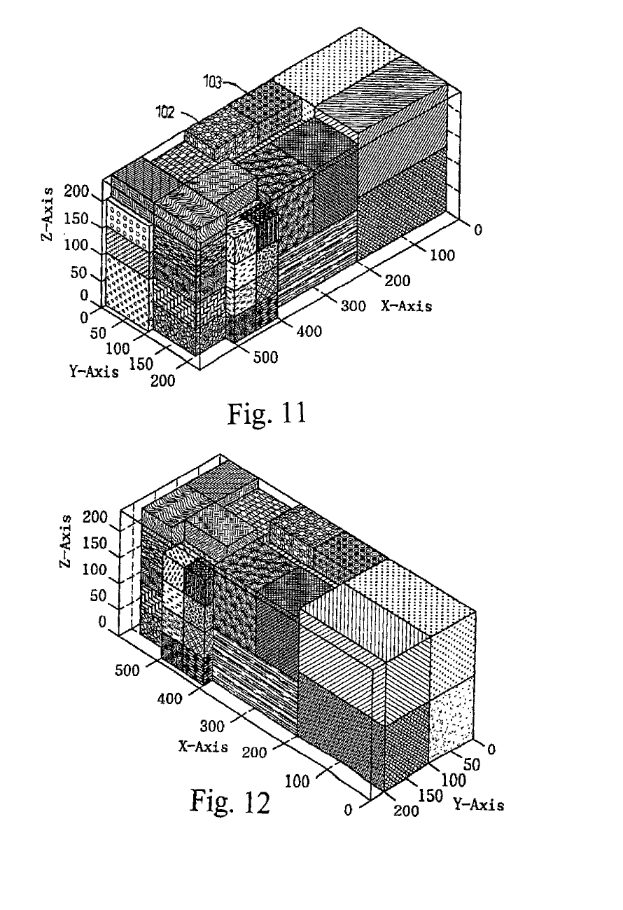

FIG. 11 depicts a perspective view of the embodiment of the present invention. In FIG. 1, all goods listed in Table 3 have been loaded into the container. The top of the goods 101 also has been filled with two goods 102 and 103, whose pressman is 2. In other words, the available space of the present invention has been fully used base on the container stability.

FIG. 12 depicts a perspective view of the embodiment of the present invention in another viewpoint. Thus, the user can understand the status of the goods arrangement by changing the viewpoint.

### EXAMPLE 2

This example illustrates the arrangement method with a plurality of storage spaces, which are contained in a cargo container with 40 feet. Five dry containers are selected in which the length, the width and the height are 1210 cm, 230 cm and 240 cm, respectively.

All goods are classified in accordance with its destination, and the goods with the same destination are disposed into the same cargo pool. The information of the goods in one of the cargo pools, such as length, width, height and amount, are listed in Table 4.

TABLE 4

| length | width | height | amount | pressmark |
|---|---|---|---|---|
| 30 | 50 | 50 | 120 | 1 |
| 100 | 70 | 40 | 45 | 2 |
| 100 | 70 | 50 | 45 | 3 |
| 80 | 80 | 80 | 40 | 4 |
| 80 | 100 | 100 | 30 | 5 |
| 100 | 100 | 120 | 30 | 6 |
| 100 | 100 | 50 | 20 | 7 |
| 100 | 80 | 50 | 25 | 8 |
| 200 | 100 | 100 | 25 | 9 |
| 200 | 100 | 120 | 25 | 10 |

All goods are loaded into the container in accordance with the arrangement steps in example 1, in which the results of the first container to fifth container are listed in Table 5 to Table 9.

Table 5 shows the results of the first container.

TABLE 5

| | dimension | | | coordinate axis | | |
|---|---|---|---|---|---|---|
| pressmark | length | width | height | x-axis | y-axis | z-axis |
| 10 | 200 | 100 | 120 | 0 | 0 | 0 |
| 10 | 200 | 100 | 120 | 0 | 0 | 120 |
| 10 | 200 | 100 | 120 | 0 | 100 | 0 |
| 10 | 200 | 100 | 120 | 0 | 100 | 120 |
| 10 | 200 | 100 | 120 | 200 | 0 | 0 |
| 10 | 200 | 100 | 120 | 200 | 0 | 120 |
| 10 | 200 | 100 | 120 | 200 | 100 | 0 |
| 10 | 200 | 100 | 120 | 200 | 100 | 120 |
| 10 | 200 | 100 | 120 | 400 | 0 | 0 |
| 10 | 200 | 100 | 120 | 400 | 0 | 120 |
| 10 | 200 | 100 | 120 | 400 | 100 | 0 |
| 10 | 200 | 100 | 120 | 400 | 100 | 120 |
| 10 | 200 | 100 | 120 | 600 | 0 | 0 |
| 10 | 200 | 100 | 120 | 600 | 0 | 120 |
| 10 | 200 | 100 | 120 | 600 | 100 | 0 |
| 10 | 200 | 100 | 120 | 600 | 100 | 120 |
| 10 | 200 | 100 | 120 | 800 | 0 | 0 |
| 10 | 200 | 100 | 120 | 800 | 0 | 120 |
| 10 | 200 | 100 | 120 | 800 | 100 | 0 |
| 10 | 200 | 100 | 120 | 800 | 100 | 120 |
| 10 | 200 | 100 | 120 | 1000 | 0 | 0 |
| 10 | 200 | 100 | 120 | 1000 | 0 | 120 |
| 10 | 200 | 100 | 120 | 1000 | 100 | 0 |
| 10 | 200 | 100 | 120 | 1000 | 100 | 120 |
| 1 | 50 | 30 | 50 | 0 | 200 | 0 |
| 1 | 50 | 30 | 50 | 0 | 200 | 50 |
| 1 | 50 | 30 | 50 | 0 | 200 | 100 |
| 1 | 50 | 30 | 50 | 0 | 200 | 150 |
| 1 | 50 | 30 | 50 | 50 | 200 | 0 |
| 1 | 50 | 30 | 50 | 50 | 200 | 50 |
| 1 | 50 | 30 | 50 | 50 | 200 | 100 |
| 1 | 50 | 30 | 50 | 50 | 200 | 150 |
| 1 | 50 | 30 | 50 | 100 | 200 | 0 |
| 1 | 50 | 30 | 50 | 100 | 200 | 50 |
| 1 | 50 | 30 | 50 | 100 | 200 | 100 |
| 1 | 50 | 30 | 50 | 100 | 200 | 150 |
| 1 | 50 | 30 | 50 | 150 | 200 | 0 |
| 1 | 50 | 30 | 50 | 150 | 200 | 50 |
| 1 | 50 | 30 | 50 | 150 | 200 | 100 |
| 1 | 50 | 30 | 50 | 150 | 200 | 150 |
| 1 | 50 | 30 | 50 | 200 | 200 | 0 |
| 1 | 50 | 30 | 50 | 200 | 200 | 50 |
| 1 | 50 | 30 | 50 | 200 | 200 | 100 |
| 1 | 50 | 30 | 50 | 200 | 200 | 150 |
| 1 | 50 | 30 | 50 | 250 | 200 | 0 |
| 1 | 50 | 30 | 50 | 250 | 200 | 50 |
| 1 | 50 | 30 | 50 | 250 | 200 | 100 |
| 1 | 50 | 30 | 50 | 250 | 200 | 150 |
| 1 | 50 | 30 | 50 | 300 | 200 | 0 |
| 1 | 50 | 30 | 50 | 300 | 200 | 50 |
| 1 | 50 | 30 | 50 | 300 | 200 | 100 |
| 1 | 50 | 30 | 50 | 300 | 200 | 150 |
| 1 | 50 | 30 | 50 | 350 | 200 | 0 |
| 1 | 50 | 30 | 50 | 350 | 200 | 50 |
| 1 | 50 | 30 | 50 | 350 | 200 | 100 |
| 1 | 50 | 30 | 50 | 350 | 200 | 150 |
| 1 | 50 | 30 | 50 | 400 | 200 | 0 |
| 1 | 50 | 30 | 50 | 400 | 200 | 50 |
| 1 | 50 | 30 | 50 | 400 | 200 | 100 |
| 1 | 50 | 30 | 50 | 400 | 200 | 150 |
| 1 | 50 | 30 | 50 | 450 | 200 | 0 |
| 1 | 50 | 30 | 50 | 450 | 200 | 50 |
| 1 | 50 | 30 | 50 | 450 | 200 | 100 |
| 1 | 50 | 30 | 50 | 450 | 200 | 150 |
| 1 | 50 | 30 | 50 | 500 | 200 | 0 |
| 1 | 50 | 30 | 50 | 500 | 200 | 50 |
| 1 | 50 | 30 | 50 | 500 | 200 | 100 |
| 1 | 50 | 30 | 50 | 500 | 200 | 150 |
| 1 | 50 | 30 | 50 | 550 | 200 | 0 |
| 1 | 50 | 30 | 50 | 550 | 200 | 50 |
| 1 | 50 | 30 | 50 | 550 | 200 | 100 |
| 1 | 50 | 30 | 50 | 550 | 200 | 150 |
| 1 | 50 | 30 | 50 | 600 | 200 | 0 |
| 1 | 50 | 30 | 50 | 600 | 200 | 50 |
| 1 | 50 | 30 | 50 | 600 | 200 | 100 |
| 1 | 50 | 30 | 50 | 600 | 200 | 150 |
| 1 | 50 | 30 | 50 | 650 | 200 | 0 |
| 1 | 50 | 30 | 50 | 650 | 200 | 50 |
| 1 | 50 | 30 | 50 | 650 | 200 | 100 |
| 1 | 50 | 30 | 50 | 650 | 200 | 150 |
| 1 | 50 | 30 | 50 | 700 | 200 | 0 |
| 1 | 50 | 30 | 50 | 700 | 200 | 50 |
| 1 | 50 | 30 | 50 | 700 | 200 | 100 |
| 1 | 50 | 30 | 50 | 700 | 200 | 150 |
| 1 | 50 | 30 | 50 | 750 | 200 | 0 |
| 1 | 50 | 30 | 50 | 750 | 200 | 50 |
| 1 | 50 | 30 | 50 | 750 | 200 | 100 |
| 1 | 50 | 30 | 50 | 750 | 200 | 150 |
| 1 | 50 | 30 | 50 | 800 | 200 | 0 |
| 1 | 50 | 30 | 50 | 800 | 200 | 50 |
| 1 | 50 | 30 | 50 | 800 | 200 | 100 |
| 1 | 50 | 30 | 50 | 800 | 200 | 150 |
| 1 | 50 | 30 | 50 | 850 | 200 | 0 |
| 1 | 50 | 30 | 50 | 850 | 200 | 50 |
| 1 | 50 | 30 | 50 | 850 | 200 | 100 |
| 1 | 50 | 30 | 50 | 850 | 200 | 150 |
| 1 | 50 | 30 | 50 | 900 | 200 | 0 |
| 1 | 50 | 30 | 50 | 900 | 200 | 50 |
| 1 | 50 | 30 | 50 | 900 | 200 | 100 |
| 1 | 50 | 30 | 50 | 900 | 200 | 150 |
| 1 | 50 | 30 | 50 | 950 | 200 | 0 |
| 1 | 50 | 30 | 50 | 950 | 200 | 50 |
| 1 | 50 | 30 | 50 | 950 | 200 | 100 |
| 1 | 50 | 30 | 50 | 950 | 200 | 150 |
| 1 | 50 | 30 | 50 | 1000 | 200 | 0 |
| 1 | 50 | 30 | 50 | 1000 | 200 | 50 |
| 1 | 50 | 30 | 50 | 1000 | 200 | 100 |
| 1 | 50 | 30 | 50 | 1000 | 200 | 150 |
| 1 | 50 | 30 | 50 | 1050 | 200 | 0 |
| 1 | 50 | 30 | 50 | 1050 | 200 | 50 |
| 1 | 50 | 30 | 50 | 1050 | 200 | 100 |
| 1 | 50 | 30 | 50 | 1050 | 200 | 150 |
| 1 | 50 | 30 | 50 | 1100 | 200 | 0 |
| 1 | 50 | 30 | 50 | 1100 | 200 | 50 |
| 1 | 50 | 30 | 50 | 1100 | 200 | 100 |
| 1 | 50 | 30 | 50 | 1100 | 200 | 150 |
| 1 | 50 | 30 | 50 | 1150 | 200 | 0 |
| 1 | 50 | 30 | 50 | 1150 | 200 | 50 |
| 1 | 50 | 30 | 50 | 1150 | 200 | 100 |
| 1 | 50 | 30 | 50 | 1150 | 200 | 150 |

Table 6 shows the results of the second container.

TABLE 6

| | dimension | | | coordinate axis | | |
|---|---|---|---|---|---|---|
| pressmark | length | width | height | x-axis | y-axis | z-axis |
| 10 | 200 | 100 | 120 | 0 | 0 | 0 |
| 9 | 200 | 100 | 100 | 0 | 0 | 120 |
| 9 | 200 | 100 | 100 | 0 | 100 | 0 |
| 9 | 200 | 100 | 100 | 0 | 100 | 100 |
| 9 | 200 | 100 | 100 | 200 | 0 | 0 |
| 9 | 200 | 100 | 100 | 200 | 0 | 100 |
| 9 | 200 | 100 | 100 | 200 | 100 | 0 |
| 9 | 200 | 100 | 100 | 200 | 100 | 100 |
| 9 | 200 | 100 | 100 | 400 | 0 | 0 |
| 9 | 200 | 100 | 100 | 400 | 0 | 100 |
| 9 | 200 | 100 | 100 | 400 | 100 | 0 |
| 9 | 200 | 100 | 100 | 400 | 100 | 100 |
| 9 | 200 | 100 | 100 | 600 | 0 | 0 |
| 9 | 200 | 100 | 100 | 600 | 0 | 100 |
| 9 | 200 | 100 | 100 | 600 | 100 | 0 |
| 9 | 200 | 100 | 100 | 600 | 100 | 100 |
| 9 | 200 | 100 | 100 | 800 | 0 | 0 |
| 9 | 200 | 100 | 100 | 800 | 0 | 100 |
| 9 | 200 | 100 | 100 | 800 | 100 | 0 |
| 9 | 200 | 100 | 100 | 800 | 100 | 100 |
| 9 | 200 | 100 | 100 | 1000 | 0 | 0 |
| 9 | 200 | 100 | 100 | 1000 | 0 | 100 |
| 9 | 200 | 100 | 100 | 1000 | 100 | 0 |
| 9 | 200 | 100 | 100 | 1000 | 100 | 100 |
| 2 | 100 | 70 | 40 | 0 | 100 | 200 |
| 2 | 100 | 70 | 40 | 100 | 100 | 200 |
| 2 | 100 | 70 | 40 | 200 | 0 | 200 |
| 2 | 100 | 70 | 40 | 200 | 70 | 200 |
| 2 | 100 | 70 | 40 | 300 | 0 | 200 |
| 2 | 100 | 70 | 40 | 300 | 70 | 200 |
| 2 | 100 | 70 | 40 | 400 | 0 | 200 |
| 2 | 100 | 70 | 40 | 400 | 70 | 200 |
| 2 | 100 | 70 | 40 | 500 | 0 | 200 |
| 2 | 100 | 70 | 40 | 500 | 70 | 200 |
| 2 | 100 | 70 | 40 | 600 | 0 | 200 |
| 2 | 100 | 70 | 40 | 600 | 70 | 200 |
| 2 | 100 | 70 | 40 | 700 | 0 | 200 |
| 2 | 100 | 70 | 40 | 700 | 70 | 200 |
| 2 | 100 | 70 | 40 | 800 | 0 | 200 |
| 2 | 100 | 70 | 40 | 800 | 70 | 200 |
| 2 | 100 | 70 | 40 | 900 | 0 | 200 |
| 2 | 100 | 70 | 40 | 900 | 70 | 200 |
| 2 | 100 | 70 | 40 | 1000 | 0 | 200 |
| 2 | 100 | 70 | 40 | 1000 | 70 | 200 |
| 2 | 100 | 70 | 40 | 1100 | 0 | 200 |
| 2 | 100 | 70 | 40 | 1100 | 70 | 200 |
| 1 | 50 | 30 | 50 | 0 | 200 | 0 |
| 1 | 50 | 30 | 50 | 0 | 200 | 50 |
| 1 | 50 | 30 | 50 | 0 | 200 | 100 |
| 1 | 50 | 30 | 50 | 0 | 200 | 150 |
| 1 | 50 | 30 | 50 | 50 | 200 | 0 |
| 1 | 50 | 30 | 50 | 50 | 200 | 50 |
| 1 | 50 | 30 | 50 | 50 | 200 | 100 |
| 1 | 50 | 30 | 50 | 50 | 200 | 150 |
| 1 | 50 | 30 | 50 | 100 | 200 | 0 |
| 1 | 50 | 30 | 50 | 100 | 200 | 50 |
| 1 | 50 | 30 | 50 | 100 | 200 | 100 |
| 1 | 50 | 30 | 50 | 100 | 200 | 150 |
| 1 | 50 | 30 | 50 | 150 | 200 | 0 |
| 1 | 50 | 30 | 50 | 150 | 200 | 50 |
| 1 | 50 | 30 | 50 | 150 | 200 | 100 |
| 1 | 50 | 30 | 50 | 150 | 200 | 150 |
| 1 | 50 | 30 | 50 | 200 | 200 | 0 |
| 1 | 50 | 30 | 50 | 200 | 200 | 50 |
| 1 | 50 | 30 | 50 | 200 | 200 | 100 |
| 1 | 50 | 30 | 50 | 200 | 200 | 150 |
| 1 | 50 | 30 | 50 | 250 | 200 | 0 |
| 1 | 50 | 30 | 50 | 250 | 200 | 50 |
| 1 | 50 | 30 | 50 | 250 | 200 | 100 |
| 1 | 50 | 30 | 50 | 250 | 200 | 150 |

Table 7 shows the results of the third container.

TABLE 7

| | dimension | | | coordinate axis | | |
|---|---|---|---|---|---|---|
| pressmark | length | width | height | x-axis | y-axis | z-axis |
| 9 | 200 | 100 | 100 | 0 | 0 | 0 |
| 9 | 200 | 100 | 100 | 0 | 0 | 100 |
| 6 | 100 | 100 | 120 | 0 | 100 | 0 |
| 6 | 100 | 100 | 120 | 0 | 100 | 120 |
| 6 | 100 | 100 | 120 | 100 | 100 | 0 |
| 6 | 100 | 100 | 120 | 100 | 100 | 120 |
| 6 | 100 | 100 | 120 | 200 | 0 | 0 |
| 6 | 100 | 100 | 120 | 200 | 0 | 120 |
| 6 | 100 | 100 | 120 | 200 | 100 | 0 |
| 6 | 100 | 100 | 120 | 200 | 100 | 120 |
| 6 | 100 | 100 | 120 | 300 | 0 | 0 |
| 6 | 100 | 100 | 120 | 300 | 0 | 120 |
| 6 | 100 | 100 | 120 | 300 | 100 | 0 |
| 6 | 100 | 100 | 120 | 300 | 100 | 120 |
| 6 | 100 | 100 | 120 | 400 | 0 | 0 |
| 6 | 100 | 100 | 120 | 400 | 0 | 120 |
| 6 | 100 | 100 | 120 | 400 | 100 | 0 |
| 6 | 100 | 100 | 120 | 400 | 100 | 120 |
| 6 | 100 | 100 | 120 | 500 | 0 | 0 |
| 6 | 100 | 100 | 120 | 500 | 0 | 120 |
| 6 | 100 | 100 | 120 | 500 | 100 | 0 |
| 6 | 100 | 100 | 120 | 500 | 100 | 120 |
| 6 | 100 | 100 | 120 | 600 | 0 | 0 |
| 6 | 100 | 100 | 120 | 600 | 0 | 120 |
| 6 | 100 | 100 | 120 | 600 | 100 | 0 |
| 6 | 100 | 100 | 120 | 600 | 100 | 120 |
| 6 | 100 | 100 | 120 | 700 | 0 | 0 |
| 6 | 100 | 100 | 120 | 700 | 0 | 120 |
| 6 | 100 | 100 | 120 | 700 | 100 | 0 |
| 6 | 100 | 100 | 120 | 700 | 100 | 120 |
| 6 | 100 | 100 | 120 | 800 | 0 | 0 |
| 6 | 100 | 100 | 120 | 800 | 0 | 120 |
| 7 | 100 | 100 | 50 | 800 | 100 | 0 |
| 7 | 100 | 100 | 50 | 800 | 100 | 50 |
| 7 | 100 | 100 | 50 | 800 | 100 | 100 |
| 7 | 100 | 100 | 50 | 800 | 100 | 150 |
| 7 | 100 | 100 | 50 | 900 | 0 | 0 |
| 7 | 100 | 100 | 50 | 900 | 0 | 50 |
| 7 | 100 | 100 | 50 | 900 | 0 | 100 |
| 7 | 100 | 100 | 50 | 900 | 0 | 150 |
| 7 | 100 | 100 | 50 | 900 | 100 | 0 |
| 7 | 100 | 100 | 50 | 900 | 100 | 50 |
| 7 | 100 | 100 | 50 | 900 | 100 | 100 |
| 7 | 100 | 100 | 50 | 900 | 100 | 150 |
| 7 | 100 | 100 | 50 | 1000 | 0 | 0 |
| 7 | 100 | 100 | 50 | 1000 | 0 | 50 |
| 7 | 100 | 100 | 50 | 1000 | 0 | 100 |
| 7 | 100 | 100 | 50 | 1000 | 0 | 150 |
| 7 | 100 | 100 | 50 | 1000 | 100 | 0 |
| 7 | 100 | 100 | 50 | 1000 | 100 | 50 |
| 7 | 100 | 100 | 50 | 1000 | 100 | 100 |
| 7 | 100 | 100 | 50 | 1000 | 100 | 150 |
| 5 | 100 | 80 | 100 | 1100 | 0 | 0 |
| 5 | 100 | 80 | 100 | 1100 | 0 | 100 |
| 5 | 100 | 80 | 100 | 1100 | 80 | 0 |
| 5 | 100 | 80 | 100 | 1100 | 80 | 100 |
| 3 | 100 | 70 | 50 | 1100 | 160 | 0 |
| 3 | 100 | 70 | 50 | 1100 | 160 | 50 |
| 3 | 100 | 70 | 50 | 1100 | 160 | 100 |
| 3 | 100 | 70 | 50 | 1100 | 160 | 150 |
| 2 | 100 | 70 | 40 | 0 | 0 | 200 |
| 2 | 100 | 70 | 40 | 100 | 0 | 200 |
| 2 | 100 | 70 | 40 | 800 | 100 | 200 |
| 2 | 100 | 70 | 40 | 900 | 0 | 200 |
| 2 | 100 | 70 | 40 | 900 | 70 | 200 |
| 2 | 100 | 70 | 40 | 1000 | 0 | 200 |
| 2 | 100 | 70 | 40 | 1000 | 70 | 200 |
| 2 | 100 | 70 | 40 | 1100 | 0 | 200 |
| 2 | 100 | 70 | 40 | 1100 | 70 | 200 |
| 2 | 100 | 70 | 40 | 1100 | 140 | 200 |

Table 8 shows the results of the fourth container.

TABLE 8

| | dimension | | | coordinate axis | | |
|---|---|---|---|---|---|---|
| pressmark | length | width | height | x-axis | y-axis | z-axis |
| 5 | 100 | 80 | 100 | 0 | 0 | 0 |
| 5 | 100 | 80 | 100 | 0 | 0 | 100 |
| 5 | 100 | 80 | 100 | 0 | 80 | 0 |
| 5 | 100 | 80 | 100 | 0 | 80 | 100 |
| 5 | 100 | 80 | 100 | 100 | 0 | 0 |
| 5 | 100 | 80 | 100 | 100 | 0 | 100 |
| 5 | 100 | 80 | 100 | 100 | 80 | 0 |
| 5 | 100 | 80 | 100 | 100 | 80 | 100 |
| 5 | 100 | 80 | 100 | 200 | 0 | 0 |
| 5 | 100 | 80 | 100 | 200 | 0 | 100 |
| 5 | 100 | 80 | 100 | 200 | 80 | 0 |
| 5 | 100 | 80 | 100 | 200 | 80 | 100 |
| 5 | 100 | 80 | 100 | 300 | 0 | 0 |
| 5 | 100 | 80 | 100 | 300 | 0 | 100 |
| 5 | 100 | 80 | 100 | 300 | 80 | 0 |
| 5 | 100 | 80 | 100 | 300 | 80 | 100 |
| 5 | 100 | 80 | 100 | 400 | 0 | 0 |
| 5 | 100 | 80 | 100 | 400 | 0 | 100 |
| 5 | 100 | 80 | 100 | 400 | 80 | 0 |
| 5 | 100 | 80 | 100 | 400 | 80 | 100 |
| 5 | 100 | 80 | 100 | 500 | 0 | 0 |
| 5 | 100 | 80 | 100 | 500 | 0 | 100 |
| 5 | 100 | 80 | 100 | 500 | 80 | 0 |
| 5 | 100 | 80 | 100 | 500 | 80 | 100 |
| 5 | 100 | 80 | 100 | 600 | 0 | 0 |
| 5 | 100 | 80 | 100 | 600 | 0 | 100 |
| 8 | 100 | 80 | 50 | 600 | 80 | 0 |
| 8 | 100 | 80 | 50 | 600 | 80 | 50 |
| 8 | 100 | 80 | 50 | 600 | 80 | 100 |
| 8 | 100 | 80 | 50 | 600 | 80 | 150 |
| 8 | 100 | 80 | 50 | 700 | 0 | 0 |
| 8 | 100 | 80 | 50 | 700 | 0 | 50 |
| 8 | 100 | 80 | 50 | 700 | 0 | 100 |
| 8 | 100 | 80 | 50 | 700 | 0 | 150 |
| 8 | 100 | 80 | 50 | 700 | 80 | 0 |
| 8 | 100 | 80 | 50 | 700 | 80 | 50 |
| 8 | 100 | 80 | 50 | 700 | 80 | 100 |
| 8 | 100 | 80 | 50 | 700 | 80 | 150 |
| 8 | 100 | 80 | 50 | 800 | 0 | 0 |
| 8 | 100 | 80 | 50 | 800 | 0 | 50 |
| 8 | 100 | 80 | 50 | 800 | 0 | 100 |
| 8 | 100 | 80 | 50 | 800 | 0 | 150 |
| 8 | 100 | 80 | 50 | 800 | 80 | 0 |
| 8 | 100 | 80 | 50 | 800 | 80 | 50 |
| 8 | 100 | 80 | 50 | 800 | 80 | 100 |
| 8 | 100 | 80 | 50 | 800 | 80 | 150 |
| 8 | 100 | 80 | 50 | 900 | 0 | 0 |
| 8 | 100 | 80 | 50 | 900 | 0 | 50 |
| 8 | 100 | 80 | 50 | 900 | 0 | 100 |
| 8 | 100 | 80 | 50 | 900 | 0 | 150 |
| 8 | 100 | 80 | 50 | 900 | 80 | 0 |
| 3 | 100 | 70 | 50 | 0 | 160 | 0 |
| 3 | 100 | 70 | 50 | 0 | 160 | 50 |
| 3 | 100 | 70 | 50 | 0 | 160 | 100 |
| 3 | 100 | 70 | 50 | 0 | 160 | 150 |
| 3 | 100 | 70 | 50 | 100 | 160 | 0 |
| 3 | 100 | 70 | 50 | 100 | 160 | 50 |
| 3 | 100 | 70 | 50 | 100 | 160 | 100 |
| 3 | 100 | 70 | 50 | 100 | 160 | 150 |
| 3 | 100 | 70 | 50 | 200 | 160 | 0 |
| 3 | 100 | 70 | 50 | 200 | 160 | 50 |
| 3 | 100 | 70 | 50 | 200 | 160 | 100 |
| 3 | 100 | 70 | 50 | 200 | 160 | 150 |
| 3 | 100 | 70 | 50 | 300 | 160 | 0 |
| 3 | 100 | 70 | 50 | 300 | 160 | 50 |
| 3 | 100 | 70 | 50 | 300 | 160 | 100 |
| 3 | 100 | 70 | 50 | 300 | 160 | 150 |
| 3 | 100 | 70 | 50 | 400 | 160 | 0 |
| 3 | 100 | 70 | 50 | 400 | 160 | 50 |
| 3 | 100 | 70 | 50 | 400 | 160 | 100 |
| 3 | 100 | 70 | 50 | 400 | 160 | 150 |
| 3 | 100 | 70 | 50 | 500 | 160 | 0 |
| 3 | 100 | 70 | 50 | 500 | 160 | 50 |
| 3 | 100 | 70 | 50 | 500 | 160 | 100 |
| 3 | 100 | 70 | 50 | 500 | 160 | 150 |
| 3 | 100 | 70 | 50 | 600 | 160 | 0 |
| 3 | 100 | 70 | 50 | 600 | 160 | 50 |
| 3 | 100 | 70 | 50 | 600 | 160 | 100 |
| 3 | 100 | 70 | 50 | 600 | 160 | 150 |
| 3 | 100 | 70 | 50 | 700 | 160 | 0 |
| 3 | 100 | 70 | 50 | 700 | 160 | 50 |
| 3 | 100 | 70 | 50 | 700 | 160 | 100 |
| 3 | 100 | 70 | 50 | 700 | 160 | 150 |
| 3 | 100 | 70 | 50 | 800 | 160 | 0 |
| 3 | 100 | 70 | 50 | 800 | 160 | 50 |
| 3 | 100 | 70 | 50 | 800 | 160 | 100 |
| 3 | 100 | 70 | 50 | 800 | 160 | 150 |
| 3 | 100 | 70 | 50 | 900 | 80 | 50 |
| 3 | 100 | 70 | 50 | 900 | 80 | 100 |
| 3 | 100 | 70 | 50 | 900 | 80 | 150 |
| 3 | 100 | 70 | 50 | 900 | 160 | 0 |
| 3 | 100 | 70 | 50 | 900 | 150 | 50 |
| 2 | 100 | 70 | 40 | 0 | 0 | 200 |
| 2 | 100 | 70 | 40 | 0 | 70 | 200 |
| 2 | 100 | 70 | 40 | 0 | 140 | 200 |
| 2 | 100 | 70 | 40 | 100 | 0 | 200 |
| 2 | 100 | 70 | 40 | 100 | 70 | 200 |
| 2 | 100 | 70 | 40 | 100 | 140 | 200 |
| 2 | 100 | 70 | 40 | 200 | 0 | 200 |
| 2 | 100 | 70 | 40 | 200 | 70 | 200 |
| 2 | 100 | 70 | 40 | 200 | 140 | 200 |
| 2 | 100 | 70 | 40 | 300 | 0 | 200 |
| 2 | 100 | 70 | 40 | 300 | 70 | 200 |
| 2 | 100 | 70 | 40 | 300 | 140 | 200 |
| 2 | 100 | 70 | 40 | 400 | 0 | 200 |
| 4 | 80 | 80 | 80 | 1000 | 0 | 0 |
| 4 | 80 | 80 | 80 | 1000 | 0 | 80 |
| 4 | 80 | 80 | 80 | 1000 | 0 | 160 |
| 4 | 80 | 80 | 80 | 1000 | 80 | 0 |
| 4 | 80 | 80 | 80 | 1000 | 80 | 80 |
| 4 | 80 | 80 | 80 | 1000 | 80 | 160 |
| 4 | 80 | 80 | 80 | 1080 | 0 | 0 |
| 4 | 80 | 80 | 80 | 1080 | 0 | 80 |
| 4 | 80 | 80 | 80 | 1080 | 0 | 160 |
| 4 | 80 | 80 | 80 | 1080 | 80 | 0 |
| 4 | 80 | 80 | 80 | 1080 | 80 | 80 |
| 4 | 80 | 80 | 80 | 1080 | 80 | 160 |

Table 9 shows the results of the fifth container.

TABLE 9

| | dimension | | | coordinate axis | | |
|---|---|---|---|---|---|---|
| pressmark | length | width | height | x-axis | y-axis | z-axis |
| 4 | 80 | 80 | 80 | 0 | 0 | 0 |
| 4 | 80 | 80 | 80 | 0 | 0 | 80 |
| 4 | 80 | 80 | 80 | 0 | 0 | 160 |
| 4 | 80 | 80 | 80 | 0 | 80 | 0 |
| 4 | 80 | 80 | 80 | 0 | 80 | 80 |
| 4 | 80 | 80 | 80 | 0 | 80 | 160 |
| 4 | 80 | 80 | 80 | 80 | 0 | 0 |
| 4 | 80 | 80 | 80 | 80 | 0 | 80 |
| 4 | 80 | 80 | 80 | 80 | 0 | 160 |
| 4 | 80 | 80 | 80 | 80 | 80 | 0 |
| 4 | 80 | 80 | 80 | 80 | 80 | 80 |
| 4 | 80 | 80 | 80 | 80 | 80 | 160 |
| 4 | 80 | 80 | 80 | 160 | 0 | 0 |
| 4 | 80 | 80 | 80 | 160 | 0 | 80 |
| 4 | 80 | 80 | 80 | 160 | 0 | 160 |
| 4 | 80 | 80 | 80 | 160 | 80 | 0 |
| 4 | 80 | 80 | 80 | 160 | 80 | 80 |
| 4 | 80 | 80 | 80 | 160 | 80 | 160 |
| 4 | 80 | 80 | 80 | 240 | 0 | 0 |
| 4 | 80 | 80 | 80 | 240 | 0 | 80 |
| 4 | 80 | 80 | 80 | 240 | 0 | 160 |
| 4 | 80 | 80 | 80 | 240 | 80 | 0 |
| 4 | 80 | 80 | 80 | 240 | 80 | 80 |
| 4 | 80 | 80 | 80 | 240 | 80 | 160 |
| 4 | 80 | 80 | 80 | 320 | 0 | 0 |
| 4 | 80 | 80 | 80 | 320 | 0 | 80 |
| 4 | 80 | 80 | 80 | 320 | 0 | 160 |
| 4 | 80 | 80 | 80 | 320 | 80 | 0 |

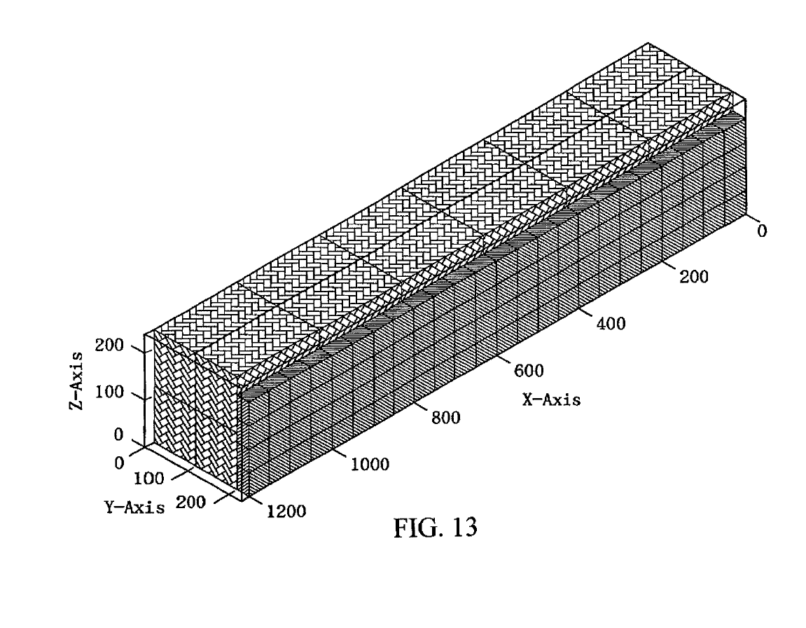

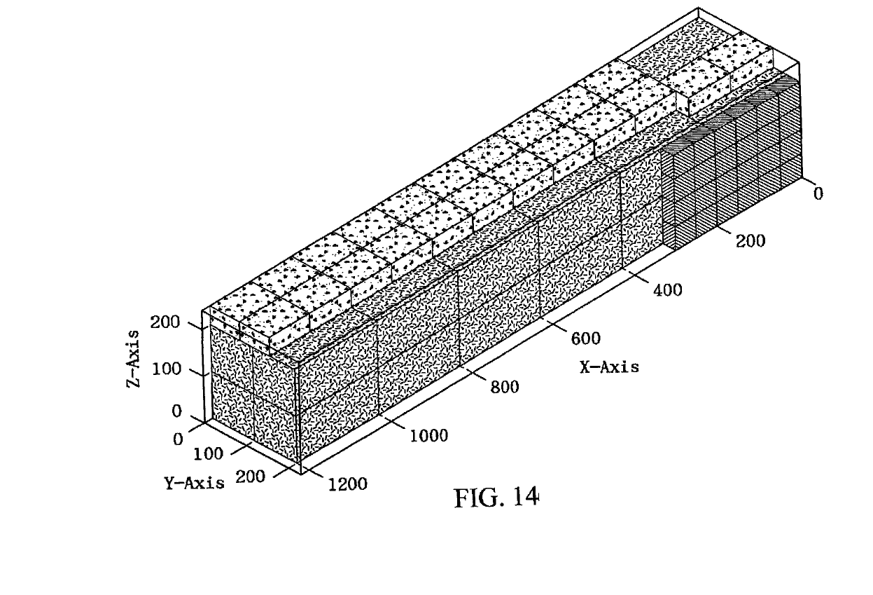

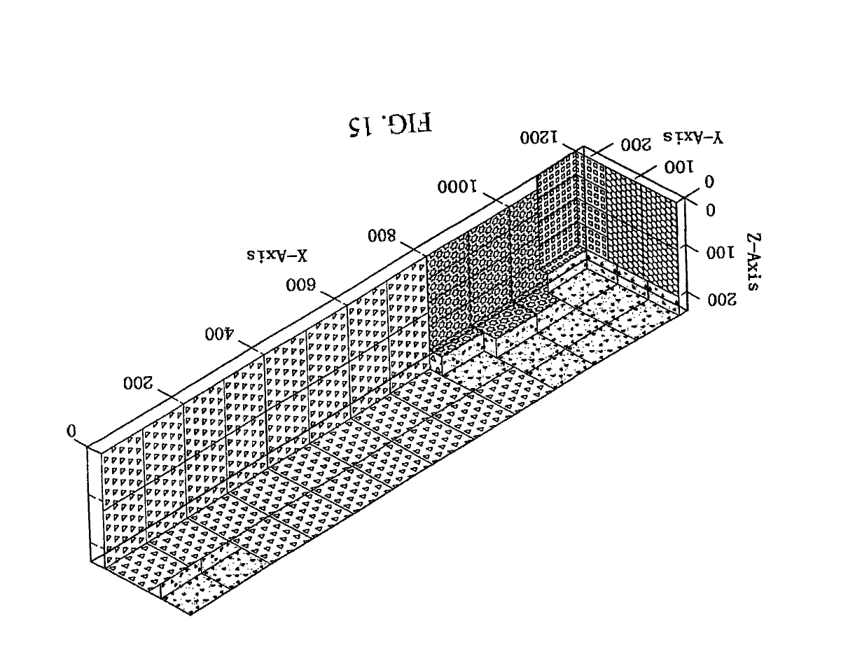

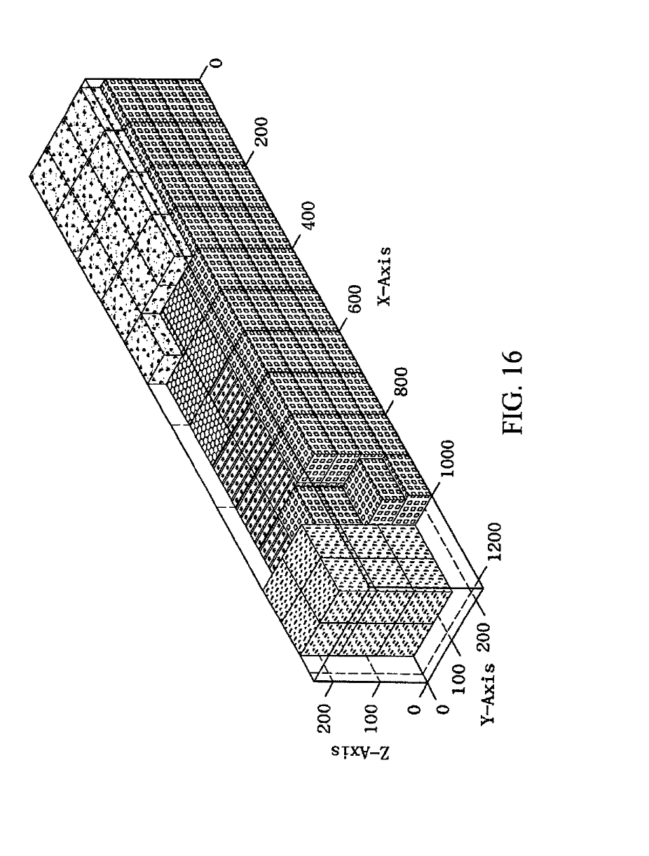

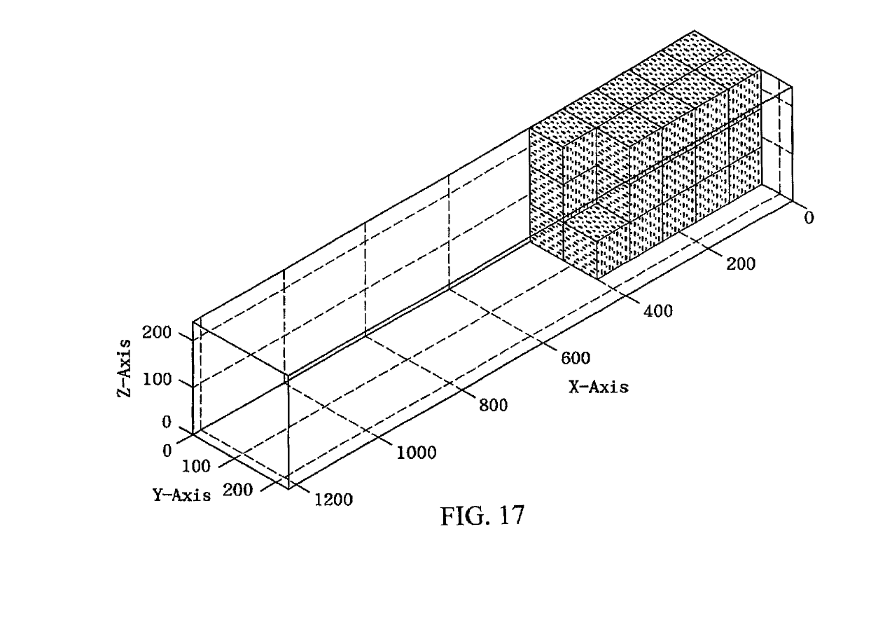

FIGS. 13 to 17 depicts the three-dimension perspective view of the first container to the fifth container of the second embodiment of the present invention.

All goods are loaded into the container according to the above results. Moreover, the residual space in the fifth container can be loaded with the goods in another cargo pool, so that the space wasteness is prevented. The amount of the goods loaded in each container and the utilization rate of the container are shown in Table 10:

TABLE 10

| pressmark | length | width | height | amount | No. 1 | No. 2 | No. 3 | No. 4 | No. 5 |
|---|---|---|---|---|---|---|---|---|---|
| 1 | 30 | 50 | 50 | 120 | 96 | 24 | | | |
| 2 | 100 | 70 | 40 | 45 | | 22 | 10 | 13 | |
| 3 | 100 | 70 | 50 | 45 | | | 4 | 41 | |
| 4 | 80 | 80 | 80 | 40 | | | | 12 | 28 |
| 5 | 80 | 100 | 100 | 30 | | | 4 | 26 | |
| 6 | 100 | 100 | 120 | 30 | | | 30 | | |
| 7 | 100 | 100 | 50 | 20 | | | 20 | | |
| 8 | 100 | 80 | 50 | 25 | | | | 25 | |
| 9 | 200 | 100 | 100 | 25 | | 23 | 2 | | |
| 10 | 200 | 100 | 120 | 25 | 24 | 1 | | | |

| | | | | | |
|---|---|---|---|---|---|
| utilization rate | 0.9702 | 0.8438 | 0.8594 | 0.8225 | 0.2146 |

### EXAMPLE 3

This example illustrates the arrangement method for considering the weight of the goods and the gravity center of the storage space, in which the storage space is a cargo container with 40 feet. Five dry containers are selected. The length, the width and the height of the dry container are 1210 cm, 230 cm and 240 cm, respectively.

Table 11 shows the results of the first container considering the weight of the goods.

TABLE 11

| | dimension | | | coordinate axis | | | | |
|---|---|---|---|---|---|---|---|---|
| pressmark | length | width | height | x-axis | y-axis | z-axis | weight | density |
| 10 | 200 | 100 | 120 | 0 | 0 | 0 | 7200000 | 3 |
| 10 | 200 | 100 | 120 | 0 | 0 | 120 | 7200000 | 3 |
| 10 | 200 | 100 | 120 | 0 | 100 | 0 | 7200000 | 3 |
| 10 | 200 | 100 | 120 | 0 | 100 | 120 | 7200000 | 3 |
| 10 | 200 | 100 | 120 | 200 | 0 | 0 | 7200000 | 3 |
| 10 | 200 | 100 | 120 | 200 | 0 | 120 | 7200000 | 3 |
| 10 | 200 | 100 | 120 | 200 | 100 | 0 | 7200000 | 3 |
| 10 | 200 | 100 | 120 | 200 | 100 | 120 | 7200000 | 3 |
| 10 | 200 | 100 | 120 | 400 | 0 | 0 | 7200000 | 3 |
| 10 | 200 | 100 | 120 | 400 | 0 | 120 | 7200000 | 3 |
| 10 | 200 | 100 | 120 | 400 | 100 | 0 | 7200000 | 3 |
| 10 | 200 | 100 | 120 | 400 | 100 | 120 | 7200000 | 3 |
| 10 | 200 | 100 | 120 | 600 | 0 | 0 | 7200000 | 3 |
| 10 | 200 | 100 | 120 | 600 | 0 | 120 | 7200000 | 3 |
| 10 | 200 | 100 | 120 | 600 | 100 | 0 | 7200000 | 3 |
| 10 | 200 | 100 | 120 | 600 | 100 | 120 | 7200000 | 3 |
| 10 | 200 | 100 | 120 | 800 | 0 | 0 | 7200000 | 3 |
| 10 | 200 | 100 | 120 | 800 | 0 | 120 | 7200000 | 3 |
| 10 | 200 | 100 | 120 | 800 | 100 | 0 | 7200000 | 3 |
| 10 | 200 | 100 | 120 | 800 | 100 | 120 | 7200000 | 3 |
| 10 | 200 | 100 | 120 | 1000 | 0 | 0 | 7200000 | 3 |
| 10 | 200 | 100 | 120 | 1000 | 0 | 120 | 7200000 | 3 |
| 10 | 200 | 100 | 120 | 1000 | 100 | 0 | 7200000 | 3 |
| 10 | 200 | 100 | 120 | 1000 | 100 | 120 | 7200000 | 3 |
| 1 | 50 | 30 | 50 | 0 | 200 | 0 | 30000 | 0.4 |
| 1 | 50 | 30 | 50 | 0 | 200 | 50 | 30000 | 0.4 |
| 1 | 50 | 30 | 50 | 0 | 200 | 100 | 30000 | 0.4 |
| 1 | 50 | 30 | 50 | 0 | 200 | 150 | 30000 | 0.4 |
| 1 | 50 | 30 | 50 | 50 | 200 | 0 | 30000 | 0.4 |
| 1 | 50 | 30 | 50 | 50 | 200 | 50 | 30000 | 0.4 |
| 1 | 50 | 30 | 50 | 50 | 200 | 100 | 30000 | 0.4 |
| 1 | 50 | 30 | 50 | 50 | 200 | 150 | 30000 | 0.4 |
| 1 | 50 | 30 | 50 | 100 | 200 | 0 | 30000 | 0.4 |
| 1 | 50 | 30 | 50 | 100 | 200 | 50 | 30000 | 0.4 |
| 1 | 50 | 30 | 50 | 100 | 200 | 100 | 30000 | 0.4 |
| 1 | 50 | 30 | 50 | 100 | 200 | 150 | 30000 | 0.4 |
| 1 | 50 | 30 | 50 | 150 | 200 | 0 | 30000 | 0.4 |
| 1 | 50 | 30 | 50 | 150 | 200 | 50 | 30000 | 0.4 |
| 1 | 50 | 30 | 50 | 150 | 200 | 100 | 30000 | 0.4 |
| 1 | 50 | 30 | 50 | 150 | 200 | 150 | 30000 | 0.4 |
| 1 | 50 | 30 | 50 | 200 | 200 | 0 | 30000 | 0.4 |
| 1 | 50 | 30 | 50 | 200 | 200 | 50 | 30000 | 0.4 |
| 1 | 50 | 30 | 50 | 200 | 200 | 100 | 30000 | 0.4 |
| 1 | 50 | 30 | 50 | 200 | 200 | 150 | 30000 | 0.4 |
| 1 | 50 | 30 | 50 | 250 | 200 | 0 | 30000 | 0.4 |
| 1 | 50 | 30 | 50 | 250 | 200 | 50 | 30000 | 0.4 |
| 1 | 50 | 30 | 50 | 250 | 200 | 100 | 30000 | 0.4 |
| 1 | 50 | 30 | 50 | 250 | 200 | 150 | 30000 | 0.4 |
| 1 | 50 | 30 | 50 | 300 | 200 | 0 | 30000 | 0.4 |
| 1 | 50 | 30 | 50 | 300 | 200 | 50 | 30000 | 0.4 |
| 1 | 50 | 30 | 50 | 300 | 200 | 100 | 30000 | 0.4 |
| 1 | 50 | 30 | 50 | 300 | 200 | 150 | 30000 | 0.4 |
| 1 | 50 | 30 | 50 | 350 | 200 | 0 | 30000 | 0.4 |
| 1 | 50 | 30 | 50 | 350 | 200 | 50 | 30000 | 0.4 |
| 1 | 50 | 30 | 50 | 350 | 200 | 100 | 30000 | 0.4 |
| 1 | 50 | 30 | 50 | 350 | 200 | 150 | 30000 | 0.4 |
| 1 | 50 | 30 | 50 | 400 | 200 | 0 | 30000 | 0.4 |
| 1 | 50 | 30 | 50 | 400 | 200 | 50 | 30000 | 0.4 |
| 1 | 50 | 30 | 50 | 400 | 200 | 100 | 30000 | 0.4 |
| 1 | 50 | 30 | 50 | 400 | 200 | 150 | 30000 | 0.4 |
| 1 | 50 | 30 | 50 | 450 | 200 | 0 | 30000 | 0.4 |
| 1 | 50 | 30 | 50 | 450 | 200 | 50 | 30000 | 0.4 |
| 1 | 50 | 30 | 50 | 450 | 200 | 100 | 30000 | 0.4 |
| 1 | 50 | 30 | 50 | 450 | 200 | 150 | 30000 | 0.4 |
| 1 | 50 | 30 | 50 | 500 | 200 | 0 | 30000 | 0.4 |
| 1 | 50 | 30 | 50 | 500 | 200 | 50 | 30000 | 0.4 |
| 1 | 50 | 30 | 50 | 500 | 200 | 100 | 30000 | 0.4 |
| 1 | 50 | 30 | 50 | 500 | 200 | 150 | 30000 | 0.4 |
| 1 | 50 | 30 | 50 | 550 | 200 | 0 | 30000 | 0.4 |
| 1 | 50 | 30 | 50 | 550 | 200 | 50 | 30000 | 0.4 |
| 1 | 50 | 30 | 50 | 550 | 200 | 100 | 30000 | 0.4 |
| 1 | 50 | 30 | 50 | 550 | 200 | 150 | 30000 | 0.4 |
| 1 | 50 | 30 | 50 | 600 | 200 | 0 | 30000 | 0.4 |
| 1 | 50 | 30 | 50 | 600 | 200 | 50 | 30000 | 0.4 |
| 1 | 50 | 30 | 50 | 600 | 200 | 100 | 30000 | 0.4 |
| 1 | 50 | 30 | 50 | 600 | 200 | 150 | 30000 | 0.4 |
| 1 | 50 | 30 | 50 | 650 | 200 | 0 | 30000 | 0.4 |
| 1 | 50 | 30 | 50 | 650 | 200 | 50 | 30000 | 0.4 |
| 1 | 50 | 30 | 50 | 650 | 200 | 100 | 30000 | 0.4 |
| 1 | 50 | 30 | 50 | 650 | 200 | 150 | 30000 | 0.4 |
| 1 | 50 | 30 | 50 | 700 | 200 | 0 | 30000 | 0.4 |
| 1 | 50 | 30 | 50 | 700 | 200 | 50 | 30000 | 0.4 |
| 1 | 50 | 30 | 50 | 700 | 200 | 100 | 30000 | 0.4 |
| 1 | 50 | 30 | 50 | 700 | 200 | 150 | 30000 | 0.4 |
| 1 | 50 | 30 | 50 | 750 | 200 | 0 | 30000 | 0.4 |
| 1 | 50 | 30 | 50 | 750 | 200 | 50 | 30000 | 0.4 |
| 1 | 50 | 30 | 50 | 750 | 200 | 100 | 30000 | 0.4 |
| 1 | 50 | 30 | 50 | 750 | 200 | 150 | 30000 | 0.4 |
| 1 | 50 | 30 | 50 | 800 | 200 | 0 | 30000 | 0.4 |
| 1 | 50 | 30 | 50 | 800 | 200 | 50 | 30000 | 0.4 |
| 1 | 50 | 30 | 50 | 800 | 200 | 100 | 30000 | 0.4 |
| 1 | 50 | 30 | 50 | 800 | 200 | 150 | 30000 | 0.4 |
| 1 | 50 | 30 | 50 | 850 | 200 | 0 | 30000 | 0.4 |
| 1 | 50 | 30 | 50 | 850 | 200 | 50 | 30000 | 0.4 |
| 1 | 50 | 30 | 50 | 850 | 200 | 100 | 30000 | 0.4 |
| 1 | 50 | 30 | 50 | 850 | 200 | 150 | 30000 | 0.4 |
| 1 | 50 | 30 | 50 | 900 | 200 | 0 | 30000 | 0.4 |
| 1 | 50 | 30 | 50 | 900 | 200 | 50 | 30000 | 0.4 |
| 1 | 50 | 30 | 50 | 900 | 200 | 100 | 30000 | 0.4 |
| 1 | 50 | 30 | 50 | 900 | 200 | 150 | 30000 | 0.4 |
| 1 | 50 | 30 | 50 | 950 | 200 | 0 | 30000 | 0.4 |
| 1 | 50 | 30 | 50 | 950 | 200 | 50 | 30000 | 0.4 |
| 1 | 50 | 30 | 50 | 950 | 200 | 100 | 30000 | 0.4 |
| 1 | 50 | 30 | 50 | 950 | 200 | 150 | 30000 | 0.4 |
| 1 | 50 | 30 | 50 | 1000 | 200 | 0 | 30000 | 0.4 |
| 1 | 50 | 30 | 50 | 1000 | 200 | 50 | 30000 | 0.4 |
| 1 | 50 | 30 | 50 | 1000 | 200 | 100 | 30000 | 0.4 |
| 1 | 50 | 30 | 50 | 1000 | 200 | 150 | 30000 | 0.4 |
| 1 | 50 | 30 | 50 | 1050 | 200 | 0 | 30000 | 0.4 |
| 1 | 50 | 30 | 50 | 1050 | 200 | 50 | 30000 | 0.4 |
| 1 | 50 | 30 | 50 | 1050 | 200 | 100 | 30000 | 0.4 |
| 1 | 50 | 30 | 50 | 1050 | 200 | 150 | 30000 | 0.4 |
| 1 | 50 | 30 | 50 | 1100 | 200 | 0 | 30000 | 0.4 |
| 1 | 50 | 30 | 50 | 1100 | 200 | 50 | 30000 | 0.4 |
| 1 | 50 | 30 | 50 | 1100 | 200 | 100 | 30000 | 0.4 |
| 1 | 50 | 30 | 50 | 1100 | 200 | 150 | 30000 | 0.4 |
| 1 | 50 | 30 | 50 | 1150 | 200 | 0 | 30000 | 0.4 |
| 1 | 50 | 30 | 50 | 1150 | 200 | 50 | 30000 | 0.4 |
| 1 | 50 | 30 | 50 | 1150 | 200 | 100 | 30000 | 0.4 |
| 1 | 50 | 30 | 50 | 1150 | 200 | 150 | 30000 | 0.4 |

Table 12 shows the results of the second container considering the weight of the goods.

TABLE 12

| | dimension | | | coordinate axis | | | | |
|---|---|---|---|---|---|---|---|---|
| pressmark | length | width | height | x-axis | y-axis | z-axis | weight | density |
| 10 | 200 | 100 | 120 | 0 | 0 | 0 | 7200000 | 3 |
| 9 | 200 | 100 | 100 | 0 | 0 | 120 | 5000000 | 2.5 |
| 9 | 200 | 100 | 100 | 0 | 100 | 0 | 5000000 | 2.5 |
| 9 | 200 | 100 | 100 | 0 | 100 | 100 | 5000000 | 2.5 |
| 9 | 200 | 100 | 100 | 200 | 0 | 0 | 5000000 | 2.5 |
| 9 | 200 | 100 | 100 | 200 | 0 | 100 | 5000000 | 2.5 |
| 9 | 200 | 100 | 100 | 200 | 100 | 0 | 5000000 | 2.5 |
| 9 | 200 | 100 | 100 | 200 | 100 | 100 | 5000000 | 2.5 |
| 9 | 200 | 100 | 100 | 400 | 0 | 0 | 5000000 | 2.5 |
| 9 | 200 | 100 | 100 | 400 | 0 | 100 | 5000000 | 2.5 |
| 9 | 200 | 100 | 100 | 400 | 100 | 0 | 5000000 | 2.5 |
| 9 | 200 | 100 | 100 | 400 | 100 | 100 | 5000000 | 2.5 |
| 9 | 200 | 100 | 100 | 600 | 0 | 0 | 5000000 | 2.5 |
| 9 | 200 | 100 | 100 | 600 | 0 | 100 | 5000000 | 2.5 |
| 9 | 200 | 100 | 100 | 600 | 100 | 0 | 5000000 | 2.5 |
| 9 | 200 | 100 | 100 | 600 | 100 | 100 | 5000000 | 2.5 |
| 9 | 200 | 100 | 100 | 800 | 0 | 0 | 5000000 | 2.5 |
| 9 | 200 | 100 | 100 | 800 | 0 | 100 | 5000000 | 2.5 |
| 9 | 200 | 100 | 100 | 800 | 100 | 0 | 5000000 | 2.5 |
| 9 | 200 | 100 | 100 | 800 | 100 | 100 | 5000000 | 2.5 |
| 9 | 200 | 100 | 100 | 1000 | 0 | 0 | 5000000 | 2.5 |
| 9 | 200 | 100 | 100 | 1000 | 0 | 100 | 5000000 | 2.5 |
| 9 | 200 | 100 | 100 | 1000 | 100 | 0 | 5000000 | 2.5 |
| 9 | 200 | 100 | 100 | 1000 | 100 | 100 | 5000000 | 2.5 |
| 2 | 100 | 70 | 40 | 0 | 100 | 200 | 420000 | 1.5 |
| 2 | 100 | 70 | 40 | 100 | 100 | 200 | 420000 | 1.5 |
| 2 | 100 | 70 | 40 | 200 | 0 | 200 | 420000 | 1.5 |
| 2 | 100 | 70 | 40 | 200 | 70 | 200 | 420000 | 1.5 |
| 2 | 100 | 70 | 40 | 300 | 0 | 200 | 420000 | 1.5 |
| 2 | 100 | 70 | 40 | 300 | 70 | 200 | 420000 | 1.5 |
| 2 | 100 | 70 | 40 | 400 | 0 | 200 | 420000 | 1.5 |
| 2 | 100 | 70 | 40 | 400 | 70 | 200 | 420000 | 1.5 |
| 2 | 100 | 70 | 40 | 500 | 0 | 200 | 420000 | 1.5 |
| 2 | 100 | 70 | 40 | 500 | 70 | 200 | 420000 | 1.5 |
| 2 | 100 | 70 | 40 | 600 | 0 | 200 | 420000 | 1.5 |
| 2 | 100 | 70 | 40 | 600 | 70 | 200 | 420000 | 1.5 |
| 2 | 100 | 70 | 40 | 700 | 0 | 200 | 420000 | 1.5 |
| 2 | 100 | 70 | 40 | 700 | 70 | 200 | 420000 | 1.5 |
| 2 | 100 | 70 | 40 | 800 | 0 | 200 | 420000 | 1.5 |
| 2 | 100 | 70 | 40 | 800 | 70 | 200 | 420000 | 1.5 |
| 2 | 100 | 70 | 40 | 900 | 0 | 200 | 420000 | 1.5 |
| 2 | 100 | 70 | 40 | 900 | 70 | 200 | 420000 | 1.5 |
| 2 | 100 | 70 | 40 | 1000 | 0 | 200 | 420000 | 1.5 |
| 2 | 100 | 70 | 40 | 1000 | 70 | 200 | 420000 | 1.5 |
| 2 | 100 | 70 | 40 | 1100 | 0 | 200 | 420000 | 1.5 |
| 2 | 100 | 70 | 40 | 1100 | 70 | 200 | 420000 | 1.5 |
| 1 | 50 | 30 | 50 | 0 | 200 | 0 | 30000 | 0.4 |
| 1 | 50 | 30 | 50 | 0 | 200 | 50 | 30000 | 0.4 |
| 1 | 50 | 30 | 50 | 0 | 200 | 100 | 30000 | 0.4 |
| 1 | 50 | 30 | 50 | 0 | 200 | 150 | 30000 | 0.4 |
| 1 | 50 | 30 | 50 | 50 | 200 | 0 | 30000 | 0.4 |
| 1 | 50 | 30 | 50 | 50 | 200 | 50 | 30000 | 0.4 |
| 1 | 50 | 30 | 50 | 50 | 200 | 100 | 30000 | 0.4 |
| 1 | 50 | 30 | 50 | 50 | 200 | 150 | 30000 | 0.4 |
| 1 | 50 | 30 | 50 | 100 | 200 | 0 | 30000 | 0.4 |
| 1 | 50 | 30 | 50 | 100 | 200 | 50 | 30000 | 0.4 |
| 1 | 50 | 30 | 50 | 100 | 200 | 100 | 30000 | 0.4 |
| 1 | 50 | 30 | 50 | 100 | 200 | 150 | 30000 | 0.4 |
| 1 | 50 | 30 | 50 | 150 | 200 | 0 | 30000 | 0.4 |
| 1 | 50 | 30 | 50 | 150 | 200 | 50 | 30000 | 0.4 |
| 1 | 50 | 30 | 50 | 150 | 200 | 100 | 30000 | 0.4 |
| 1 | 50 | 30 | 50 | 150 | 200 | 150 | 30000 | 0.4 |
| 1 | 50 | 30 | 50 | 200 | 200 | 0 | 30000 | 0.4 |
| 1 | 50 | 30 | 50 | 200 | 200 | 50 | 30000 | 0.4 |
| 1 | 50 | 30 | 50 | 200 | 200 | 100 | 30000 | 0.4 |
| 1 | 50 | 30 | 50 | 200 | 200 | 150 | 30000 | 0.4 |
| 1 | 50 | 30 | 50 | 250 | 200 | 0 | 30000 | 0.4 |
| 1 | 50 | 30 | 50 | 250 | 200 | 50 | 30000 | 0.4 |
| 1 | 50 | 30 | 50 | 250 | 200 | 100 | 30000 | 0.4 |
| 1 | 50 | 30 | 50 | 250 | 200 | 150 | 30000 | 0.4 |

Table 13 shows the results of the third container for considering the weight of the goods.

TABLE 13

| | dimension | | | coordinate axis | | | | |
|---|---|---|---|---|---|---|---|---|
| pressmark | length | width | height | x-axis | y-axis | z-axis | weight | Density |
| 9 | 200 | 100 | 100 | 0 | 0 | 0 | 5000000 | 2.5 |
| 9 | 200 | 100 | 100 | 0 | 0 | 100 | 5000000 | 2.5 |
| 6 | 100 | 100 | 120 | 0 | 100 | 0 | 1800000 | 1.5 |
| 6 | 100 | 100 | 120 | 0 | 100 | 120 | 1800000 | 1.5 |
| 6 | 100 | 100 | 120 | 100 | 100 | 0 | 1800000 | 1.5 |
| 6 | 100 | 100 | 120 | 100 | 100 | 120 | 1800000 | 1.5 |
| 6 | 100 | 100 | 120 | 200 | 0 | 0 | 1800000 | 1.5 |
| 6 | 100 | 100 | 120 | 200 | 0 | 120 | 1800000 | 1.5 |
| 6 | 100 | 100 | 120 | 200 | 100 | 0 | 1800000 | 1.5 |
| 6 | 100 | 100 | 120 | 200 | 100 | 120 | 1800000 | 1.5 |
| 6 | 100 | 100 | 120 | 300 | 0 | 0 | 1800000 | 1.5 |
| 6 | 100 | 100 | 120 | 300 | 0 | 120 | 1800000 | 1.5 |
| 6 | 100 | 100 | 120 | 300 | 100 | 0 | 1800000 | 1.5 |
| 6 | 100 | 100 | 120 | 300 | 100 | 120 | 1800000 | 1.5 |
| 6 | 100 | 100 | 120 | 400 | 0 | 0 | 1800000 | 1.5 |
| 6 | 100 | 100 | 120 | 400 | 0 | 120 | 1800000 | 1.5 |
| 6 | 100 | 100 | 120 | 400 | 100 | 0 | 1800000 | 1.5 |
| 6 | 100 | 100 | 120 | 400 | 100 | 120 | 1800000 | 1.5 |
| 6 | 100 | 100 | 120 | 500 | 0 | 0 | 1800000 | 1.5 |
| 6 | 100 | 100 | 120 | 500 | 0 | 120 | 1800000 | 1.5 |
| 6 | 100 | 100 | 120 | 500 | 100 | 0 | 1800000 | 1.5 |
| 6 | 100 | 100 | 120 | 500 | 100 | 120 | 1800000 | 1.5 |
| 6 | 100 | 100 | 120 | 600 | 0 | 0 | 1800000 | 1.5 |
| 6 | 100 | 100 | 120 | 600 | 0 | 120 | 1800000 | 1.5 |
| 6 | 100 | 100 | 120 | 600 | 100 | 0 | 1800000 | 1.5 |
| 6 | 100 | 100 | 120 | 600 | 100 | 120 | 1800000 | 1.5 |
| 6 | 100 | 100 | 120 | 700 | 0 | 0 | 1800000 | 1.5 |
| 6 | 100 | 100 | 120 | 700 | 0 | 120 | 1800000 | 1.5 |
| 6 | 100 | 100 | 120 | 700 | 100 | 0 | 1800000 | 1.5 |
| 6 | 100 | 100 | 120 | 700 | 100 | 120 | 1800000 | 1.5 |
| 6 | 100 | 100 | 120 | 800 | 0 | 0 | 1800000 | 1.5 |
| 6 | 100 | 100 | 120 | 800 | 0 | 120 | 1800000 | 1.5 |
| 7 | 100 | 100 | 50 | 800 | 100 | 0 | 750000 | 1.5 |
| 7 | 100 | 100 | 50 | 800 | 100 | 50 | 750000 | 1.5 |
| 7 | 100 | 100 | 50 | 800 | 100 | 100 | 750000 | 1.5 |
| 7 | 100 | 100 | 50 | 800 | 100 | 150 | 750000 | 1.5 |
| 7 | 100 | 100 | 50 | 900 | 0 | 0 | 750000 | 1.5 |
| 7 | 100 | 100 | 50 | 900 | 0 | 50 | 750000 | 1.5 |
| 7 | 100 | 100 | 50 | 900 | 0 | 100 | 750000 | 1.5 |
| 7 | 100 | 100 | 50 | 900 | 0 | 150 | 750000 | 1.5 |
| 7 | 100 | 100 | 50 | 900 | 100 | 0 | 750000 | 1.5 |
| 7 | 100 | 100 | 50 | 900 | 100 | 50 | 750000 | 1.5 |
| 7 | 100 | 100 | 50 | 900 | 100 | 100 | 750000 | 1.5 |
| 7 | 100 | 100 | 50 | 900 | 100 | 150 | 750000 | 1.5 |
| 7 | 100 | 100 | 50 | 1000 | 0 | 0 | 750000 | 1.5 |
| 7 | 100 | 100 | 50 | 1000 | 0 | 50 | 750000 | 1.5 |
| 7 | 100 | 100 | 50 | 1000 | 0 | 100 | 750000 | 1.5 |
| 7 | 100 | 100 | 50 | 1000 | 0 | 150 | 750000 | 1.5 |
| 7 | 100 | 100 | 50 | 1000 | 100 | 0 | 750000 | 1.5 |
| 7 | 100 | 100 | 50 | 1000 | 100 | 50 | 750000 | 1.5 |
| 7 | 100 | 100 | 50 | 1000 | 100 | 100 | 750000 | 1.5 |
| 7 | 100 | 100 | 50 | 1000 | 100 | 150 | 750000 | 1.5 |
| 5 | 100 | 80 | 100 | 1100 | 0 | 0 | 1600000 | 2 |
| 5 | 100 | 80 | 100 | 1100 | 0 | 100 | 1600000 | 2 |
| 5 | 100 | 80 | 100 | 1100 | 80 | 0 | 1600000 | 2 |
| 5 | 100 | 80 | 100 | 1100 | 80 | 100 | 1600000 | 2 |
| 3 | 100 | 70 | 50 | 1100 | 160 | 0 | 350000 | 1 |
| 3 | 100 | 70 | 50 | 1100 | 160 | 50 | 350000 | 1 |
| 3 | 100 | 70 | 50 | 1100 | 160 | 100 | 350000 | 1 |
| 3 | 100 | 70 | 50 | 1100 | 160 | 150 | 350000 | 1 |
| 2 | 100 | 70 | 40 | 0 | 0 | 200 | 420000 | 1.5 |
| 2 | 100 | 70 | 40 | 100 | 0 | 200 | 420000 | 1.5 |
| 2 | 100 | 70 | 40 | 800 | 100 | 200 | 420000 | 1.5 |
| 2 | 100 | 70 | 40 | 900 | 0 | 200 | 420000 | 1.5 |
| 2 | 100 | 70 | 40 | 900 | 70 | 200 | 420000 | 1.5 |
| 2 | 100 | 70 | 40 | 1000 | 0 | 200 | 420000 | 1.5 |
| 2 | 100 | 70 | 40 | 1000 | 70 | 200 | 420000 | 1.5 |
| 2 | 100 | 70 | 40 | 1100 | 0 | 200 | 420000 | 1.5 |
| 2 | 100 | 70 | 40 | 1100 | 70 | 200 | 420000 | 1.5 |
| 2 | 100 | 70 | 40 | 1100 | 140 | 200 | 420000 | 1.5 |

Table 14 shows the results of the fourth container for considering the weight of the goods.

TABLE 14

| | dimension | | | coordinate axis | | | | |
|---|---|---|---|---|---|---|---|---|
| pressmark | length | width | height | x-axis | y-axis | z-axis | weight | Density |
| 5 | 100 | 80 | 100 | 0 | 0 | 0 | 1600000 | 2 |
| 5 | 100 | 80 | 100 | 0 | 0 | 100 | 1600000 | 2 |
| 5 | 100 | 80 | 100 | 0 | 80 | 0 | 1600000 | 2 |
| 5 | 100 | 80 | 100 | 0 | 80 | 100 | 1600000 | 2 |
| 5 | 100 | 80 | 100 | 100 | 0 | 0 | 1600000 | 2 |
| 5 | 100 | 80 | 100 | 100 | 0 | 100 | 1600000 | 2 |
| 5 | 100 | 80 | 100 | 100 | 80 | 0 | 1600000 | 2 |
| 5 | 100 | 80 | 100 | 100 | 80 | 100 | 1600000 | 2 |
| 5 | 100 | 80 | 100 | 200 | 0 | 0 | 1600000 | 2 |
| 5 | 100 | 80 | 100 | 200 | 0 | 100 | 1600000 | 2 |
| 5 | 100 | 80 | 100 | 200 | 80 | 0 | 1600000 | 2 |
| 5 | 100 | 80 | 100 | 200 | 80 | 100 | 1600000 | 2 |
| 5 | 100 | 80 | 100 | 300 | 0 | 0 | 1600000 | 2 |
| 5 | 100 | 80 | 100 | 300 | 0 | 100 | 1600000 | 2 |
| 5 | 100 | 80 | 100 | 300 | 80 | 0 | 1600000 | 2 |
| 5 | 100 | 80 | 100 | 300 | 80 | 100 | 1600000 | 2 |
| 5 | 100 | 80 | 100 | 400 | 0 | 0 | 1600000 | 2 |
| 5 | 100 | 80 | 100 | 400 | 0 | 100 | 1600000 | 2 |
| 5 | 100 | 80 | 100 | 400 | 80 | 0 | 1600000 | 2 |
| 5 | 100 | 80 | 100 | 400 | 80 | 100 | 1600000 | 2 |
| 5 | 100 | 80 | 100 | 500 | 0 | 0 | 1600000 | 2 |
| 5 | 100 | 80 | 100 | 500 | 0 | 100 | 1600000 | 2 |
| 5 | 100 | 80 | 100 | 500 | 80 | 0 | 1600000 | 2 |
| 5 | 100 | 80 | 100 | 500 | 80 | 100 | 1600000 | 2 |
| 5 | 100 | 80 | 100 | 600 | 0 | 0 | 1600000 | 2 |
| 5 | 100 | 80 | 100 | 600 | 0 | 100 | 1600000 | 2 |
| 8 | 100 | 80 | 50 | 600 | 80 | 0 | 800000 | 2 |
| 8 | 100 | 80 | 50 | 600 | 80 | 50 | 800000 | 2 |
| 8 | 100 | 80 | 50 | 600 | 80 | 100 | 800000 | 2 |
| 8 | 100 | 80 | 50 | 600 | 80 | 150 | 800000 | 2 |
| 8 | 100 | 80 | 50 | 700 | 0 | 0 | 800000 | 2 |
| 8 | 100 | 80 | 50 | 700 | 0 | 50 | 800000 | 2 |
| 8 | 100 | 80 | 50 | 700 | 0 | 100 | 800000 | 2 |
| 8 | 100 | 80 | 50 | 700 | 0 | 150 | 800000 | 2 |
| 8 | 100 | 80 | 50 | 700 | 80 | 0 | 800000 | 2 |
| 8 | 100 | 80 | 50 | 700 | 80 | 50 | 800000 | 2 |
| 8 | 100 | 80 | 50 | 700 | 80 | 100 | 800000 | 2 |
| 8 | 100 | 80 | 50 | 700 | 80 | 150 | 800000 | 2 |
| 8 | 100 | 80 | 50 | 800 | 0 | 0 | 800000 | 2 |
| 8 | 100 | 80 | 50 | 800 | 0 | 50 | 800000 | 2 |
| 8 | 100 | 80 | 50 | 800 | 0 | 100 | 800000 | 2 |
| 8 | 100 | 80 | 50 | 800 | 0 | 150 | 800000 | 2 |
| 8 | 100 | 80 | 50 | 800 | 80 | 0 | 800000 | 2 |
| 8 | 100 | 80 | 50 | 800 | 80 | 50 | 800000 | 2 |
| 8 | 100 | 80 | 50 | 800 | 80 | 100 | 800000 | 2 |
| 8 | 100 | 80 | 50 | 800 | 80 | 150 | 800000 | 2 |
| 8 | 100 | 80 | 50 | 900 | 0 | 0 | 800000 | 2 |
| 8 | 100 | 80 | 50 | 900 | 0 | 50 | 800000 | 2 |
| 8 | 100 | 80 | 50 | 900 | 0 | 100 | 800000 | 2 |
| 8 | 100 | 80 | 50 | 900 | 0 | 150 | 800000 | 2 |
| 8 | 100 | 80 | 50 | 900 | 80 | 0 | 800000 | 2 |
| 3 | 100 | 70 | 50 | 0 | 160 | 0 | 350000 | 1 |
| 3 | 100 | 70 | 50 | 0 | 160 | 50 | 350000 | 1 |
| 3 | 100 | 70 | 50 | 0 | 160 | 100 | 350000 | 1 |
| 3 | 100 | 70 | 50 | 0 | 160 | 150 | 350000 | 1 |
| 3 | 100 | 70 | 50 | 100 | 160 | 0 | 350000 | 1 |
| 3 | 100 | 70 | 50 | 100 | 160 | 50 | 350000 | 1 |
| 3 | 100 | 70 | 50 | 100 | 160 | 100 | 350000 | 1 |
| 3 | 100 | 70 | 50 | 100 | 160 | 150 | 350000 | 1 |
| 3 | 100 | 70 | 50 | 200 | 160 | 0 | 350000 | 1 |
| 3 | 100 | 70 | 50 | 200 | 160 | 50 | 350000 | 1 |
| 3 | 100 | 70 | 50 | 200 | 160 | 100 | 350000 | 1 |
| 3 | 100 | 70 | 50 | 200 | 160 | 150 | 350000 | 1 |
| 3 | 100 | 70 | 50 | 300 | 160 | 0 | 350000 | 1 |
| 3 | 100 | 70 | 50 | 300 | 160 | 50 | 350000 | 1 |
| 3 | 100 | 70 | 50 | 300 | 160 | 100 | 350000 | 1 |
| 3 | 100 | 70 | 50 | 300 | 160 | 150 | 350000 | 1 |
| 3 | 100 | 70 | 50 | 400 | 160 | 0 | 350000 | 1 |
| 3 | 100 | 70 | 50 | 400 | 160 | 50 | 350000 | 1 |
| 3 | 100 | 70 | 50 | 400 | 160 | 100 | 350000 | 1 |
| 3 | 100 | 70 | 50 | 400 | 160 | 150 | 350000 | 1 |
| 3 | 100 | 70 | 50 | 500 | 160 | 0 | 350000 | 1 |
| 3 | 100 | 70 | 50 | 500 | 160 | 50 | 350000 | 1 |
| 3 | 100 | 70 | 50 | 500 | 160 | 100 | 350000 | 1 |
| 3 | 100 | 70 | 50 | 500 | 160 | 150 | 350000 | 1 |
| 3 | 100 | 70 | 50 | 600 | 160 | 0 | 350000 | 1 |
| 3 | 100 | 70 | 50 | 600 | 160 | 50 | 350000 | 1 |
| 3 | 100 | 70 | 50 | 600 | 160 | 100 | 350000 | 1 |
| 3 | 100 | 70 | 50 | 600 | 160 | 150 | 350000 | 1 |
| 3 | 100 | 70 | 50 | 700 | 160 | 0 | 350000 | 1 |
| 3 | 100 | 70 | 50 | 700 | 160 | 50 | 350000 | 1 |
| 3 | 100 | 70 | 50 | 700 | 160 | 100 | 350000 | 1 |
| 3 | 100 | 70 | 50 | 700 | 160 | 150 | 350000 | 1 |
| 3 | 100 | 70 | 50 | 800 | 160 | 0 | 350000 | 1 |
| 3 | 100 | 70 | 50 | 800 | 160 | 50 | 350000 | 1 |
| 3 | 100 | 70 | 50 | 800 | 160 | 100 | 350000 | 1 |
| 3 | 100 | 70 | 50 | 800 | 160 | 150 | 350000 | 1 |
| 3 | 100 | 70 | 50 | 900 | 80 | 50 | 350000 | 1 |
| 3 | 100 | 70 | 50 | 900 | 80 | 100 | 350000 | 1 |
| 3 | 100 | 70 | 50 | 900 | 80 | 150 | 350000 | 1 |
| 3 | 100 | 70 | 50 | 900 | 160 | 0 | 350000 | 1 |
| 3 | 100 | 70 | 50 | 900 | 150 | 50 | 350000 | 1 |
| 2 | 100 | 70 | 40 | 0 | 0 | 200 | 420000 | 1.5 |
| 2 | 100 | 70 | 40 | 0 | 70 | 200 | 420000 | 1.5 |
| 2 | 100 | 70 | 40 | 0 | 140 | 200 | 420000 | 1.5 |
| 2 | 100 | 70 | 40 | 100 | 0 | 200 | 420000 | 1.5 |
| 2 | 100 | 70 | 40 | 100 | 70 | 200 | 420000 | 1.5 |
| 2 | 100 | 70 | 40 | 100 | 140 | 200 | 420000 | 1.5 |
| 2 | 100 | 70 | 40 | 200 | 0 | 200 | 420000 | 1.5 |
| 2 | 100 | 70 | 40 | 200 | 70 | 200 | 420000 | 1.5 |
| 2 | 100 | 70 | 40 | 200 | 140 | 200 | 420000 | 1.5 |
| 2 | 100 | 70 | 40 | 300 | 0 | 200 | 420000 | 1.5 |
| 2 | 100 | 70 | 40 | 300 | 70 | 200 | 420000 | 1.5 |
| 2 | 100 | 70 | 40 | 300 | 140 | 200 | 420000 | 1.5 |
| 2 | 100 | 70 | 40 | 400 | 0 | 200 | 420000 | 1.5 |
| 4 | 80 | 80 | 80 | 1000 | 0 | 0 | 256000 | 0.5 |
| 4 | 80 | 80 | 80 | 1000 | 0 | 80 | 256000 | 0.5 |
| 4 | 80 | 80 | 80 | 1000 | 0 | 160 | 256000 | 0.5 |
| 4 | 80 | 80 | 80 | 1000 | 80 | 0 | 256000 | 0.5 |
| 4 | 80 | 80 | 80 | 1000 | 80 | 80 | 256000 | 0.5 |
| 4 | 80 | 80 | 80 | 1000 | 80 | 160 | 256000 | 0.5 |
| 4 | 80 | 80 | 80 | 1080 | 0 | 0 | 256000 | 0.5 |
| 4 | 80 | 80 | 80 | 1080 | 0 | 80 | 256000 | 0.5 |
| 4 | 80 | 80 | 80 | 1080 | 0 | 160 | 256000 | 0.5 |
| 4 | 80 | 80 | 80 | 1080 | 80 | 0 | 256000 | 0.5 |
| 4 | 80 | 80 | 80 | 1080 | 80 | 80 | 256000 | 0.5 |
| 4 | 80 | 80 | 80 | 1080 | 80 | 160 | 256000 | 0.5 |

Table shows is the results of the fifth container for considering the weight of the goods.

TABLE 15

| | dimension | | | coordinate axis | | | | |
|---|---|---|---|---|---|---|---|---|
| pressmark | length | width | height | x-axis | y-axis | z-axis | weight | density |
| 4 | 80 | 80 | 80 | 0 | 0 | 0 | 256000 | 0.5 |
| 4 | 80 | 80 | 80 | 0 | 0 | 80 | 256000 | 0.5 |
| 4 | 80 | 80 | 80 | 0 | 0 | 160 | 256000 | 0.5 |
| 4 | 80 | 80 | 80 | 0 | 80 | 0 | 256000 | 0.5 |
| 4 | 80 | 80 | 80 | 0 | 80 | 80 | 256000 | 0.5 |
| 4 | 80 | 80 | 80 | 0 | 80 | 160 | 256000 | 0.5 |
| 4 | 80 | 80 | 80 | 80 | 0 | 0 | 256000 | 0.5 |
| 4 | 80 | 80 | 80 | 80 | 0 | 80 | 256000 | 0.5 |
| 4 | 80 | 80 | 80 | 80 | 0 | 160 | 256000 | 0.5 |
| 4 | 80 | 80 | 80 | 80 | 80 | 0 | 256000 | 0.5 |
| 4 | 80 | 80 | 80 | 80 | 80 | 80 | 256000 | 0.5 |
| 4 | 80 | 80 | 80 | 80 | 80 | 160 | 256000 | 0.5 |
| 4 | 80 | 80 | 80 | 160 | 0 | 0 | 256000 | 0.5 |
| 4 | 80 | 80 | 80 | 160 | 0 | 80 | 256000 | 0.5 |
| 4 | 80 | 80 | 80 | 160 | 0 | 160 | 256000 | 0.5 |
| 4 | 80 | 80 | 80 | 160 | 80 | 0 | 256000 | 0.5 |
| 4 | 80 | 80 | 80 | 160 | 80 | 80 | 256000 | 0.5 |
| 4 | 80 | 80 | 80 | 160 | 80 | 160 | 256000 | 0.5 |
| 4 | 80 | 80 | 80 | 240 | 0 | 0 | 256000 | 0.5 |
| 4 | 80 | 80 | 80 | 240 | 0 | 80 | 256000 | 0.5 |
| 4 | 80 | 80 | 80 | 240 | 0 | 160 | 256000 | 0.5 |
| 4 | 80 | 80 | 80 | 240 | 80 | 0 | 256000 | 0.5 |
| 4 | 80 | 80 | 80 | 240 | 80 | 80 | 256000 | 0.5 |
| 4 | 80 | 80 | 80 | 240 | 80 | 160 | 256000 | 0.5 |
| 4 | 80 | 80 | 80 | 320 | 0 | 0 | 256000 | 0.5 |
| 4 | 80 | 80 | 80 | 320 | 0 | 80 | 256000 | 0.5 |
| 4 | 80 | 80 | 80 | 320 | 0 | 160 | 256000 | 0.5 |
| 4 | 80 | 80 | 80 | 320 | 80 | 0 | 256000 | 0.5 |

Moreover, the arrangement method of the present invention can be recorded in various media, such as a disc, a CD, a hard disc or other memories which can be read by the computer.

The methods and features of this invention have been sufficiently described in the above examples and descriptions. It should be understood that any modifications or changes without departing from the spirits of the invention are intended to be covered in the protection scopes of the invention.

What is claimed is:

1. A method of arranging goods for use in goods transportation and storage, comprising the following steps:
(a) inputting related information of the goods, which should be placed into a storage space, wherein the related information at least comprises the size of the goods;
(b) determining a placing priority of the goods in accordance with a ranking rule;
(c) selecting goods of the first priority for placing into the storage space;
(d) placing the selected goods into an available space;
(e) searching and combining available spaces in the storage space;
(f) determining whether goods of the next priority exist or not, if it is affirmative, proceeding to the step (g); otherwise, proceeding to the step (i)
(g) treating the goods of the next priority as the selected goods at the moment;
(h) inspecting whether the size of the available space in the storage space is larger than the size of the selected goods or not, if it is affirmative, proceeding to step (c); otherwise proceeding to step (f); and
(i) outputting the result of the goods arrangement.

2. The method of claim 1, wherein the ranking rule of the step (b) needs to be performed in the following order:
rank 1: selecting the goods with the highest cost effective benefit;
rank 2: selecting the goods with the largest base dimensions; and
rank 3: selecting the goods with the largest base area.

3. The method of claim 2, in which the cost effective benefit of the goods in rank 1 is obtained from dividing the transportation cost of the goods by the volume of the goods.

4. The method of claim 2, in which the cost effective benefit of the goods in rank 1 is obtained from dividing the transportation cost of the goods the weight of the goods.

5. The method of claim 1, wherein the ranking rule of the step (b) comprises:
rank 4: selecting the goods with the maximal density;
rank 5: selecting the goods with the maximal length;
rank 6: selecting the goods with the maximal width; and
rank 7: selecting the goods with the maximal height.

6. The method of claim 5, in which the order from rank 4 to rank 7 is unrestricted.

7. The method of claim 1, in which the selected goods of step (d) can be rotated to the left side and to the right side in the available space to obtain an optimal orientation.

8. The method of claim 1, wherein the selected goods of step (d) is tacked to build a vertical column; if the space on top of the vertical column can not accommodate the goods of the next priority, the goods of the next priority will be placed in the space adjacent to the vertical column for building another vertical column; accordingly, a lateral wall or a longitudinal wall is built.

9. The method of claim 8, wherein the goods placed in the same vertical column can be vertically interchanged according to the density or the weight of the goods.

10. The method of claim 8, wherein the lateral wall or the longitudinal wall can be exchanged in the storage space to balance the gravity center of the storage space.

11. A method for arranging goods for use in goods transportation and storage, comprising the following steps:
(a) inputting related information of the goods, which should be placed into a storage space, wherein the related information at least comprises the size of the goods;
(b) determining the priority for arranging the goods according to a ranking rule;
(c) searching and combining available spaces of the storage space;
(d) determining whether the available space of the storage space exists or not, if it is affirmative, then proceeding to the step (e); otherwise, proceeding to the step (g);
(e) selecting goods according to a heuristic algorithm and arranging the selected goods into an available space;
(f) determining whether the unselected goods exist or not, if it is affirmative, then proceeding to step (c); otherwise, proceeding to step (g); and
(g) stopping the operation and outputting the result.

12. The method of claim 11, wherein the ranking rule of step (b) needs to be performed in the following order:
rank 1: selecting the goods with the highest cost benefit;
rank 2: selecting the goods with the largest base dimensions; and
rank 3: selecting the goods with the largest base area.

13. The method of claim 12, in which the cost effective benefit of the goods in rank 1 is obtained from dividing the transportation cost of the goods by the volume of the goods.

14. The method of claim 12, in which the cost effective benefit of the goods in rank 1 is obtained from dividing the transportation cost of the goods by the weight of the goods.

15. The method of claim 11, wherein the ranking rule of the step (b) comprises the following ranks:
rank 4: selecting the goods with the maximal density;
rank 5: selecting the goods with the maximal length;
rank 6: selecting the goods with the maximal width; and
rank 7: selecting the goods with the maximal height.

16. The method of claim 15, in which the order from rank 4 to rank 7 is unrestricted.

17. The method of claim 11, wherein the heuristic algorithm of step (e) comprising the following steps.
(a) selecting goods of a next priority according the ranking rule, if the size of the available space is smaller than the size of the selected goods; and
(b) rotating the base of the goods for a perfect orientation.

18. The method of claim 11, wherein the heuristic algorithm of step (e) comprises the following steps.
(a) selecting the goods of a next priority according the ranking rule, if the size of the available space is smaller than the size of the selected goods;
(b) keeping the selected goods upright;
(c) stacking the selected goods for building a vertical column; and
(d) combining vertical columns of the goods for building a lateral wall or a longitudinal wall.

19. The method of claim 18, wherein the goods placed in the same vertical column can be interchanged according to the density and the weight of the goods.

20. The method of claim 8, wherein the lateral wall or the longitudinal wall can be exchanged in the storage space to balance the gravity center of the storage space.

21. A system for arranging goods for use in goods transportation and storage, comprising:
a database for storing related information of a storage space and the goods, which should be placed into the storage space, wherein the related information at least comprises the size of the goods and the available space of the storage space;
a core computation engine electrically connected to the database for computing a priority of the goods, location and orientation by a heuristic algorithm, wherein the heuristic algorithm comprising the steps as follow:
(a) selecting the goods of a next priority in accordance with the ranking rule, if the size of the available space is smaller than the size of the selected goods;
(b) rotating the base of the selected goods for a perfect orientation; (b) keeping the selected goods upright;
(c) stacking the selected goods for building a vertical column; and
(d) combining vertical columns for building a lateral wall or a longitudinal wall; and an I/O mechanism electrically connected to the core computation engine for listing the information of the goods and illustrating the loading pattern of the goods.

22. The system of the claim 21, in which the I/O mechanism is one of a personal computer, personal digital assistant, notebook computer and a cellular phone.

23. The system of the claim 21, in which the I/O mechanism is connected with the core computation engine in a wired or wireless communication manner.

24. The system of the claim 21, in which the core computation engine computes the priority for arranging the goods in accordance with the ranking rule, comprising:
rank 1: selecting the goods with the highest cost effective benefit;
rank 2: selecting the goods with the largest base dimensions; and
rank 3: selecting the goods with the largest base area.

25. The method of claim 24, in which the cost effective benefit of the goods in rank 1 is obtained from dividing the transportation cost of the goods by the volume of the goods.

26. The method of claim 24, in which the cost effective benefit of the goods in rank 1 is obtained from dividing the transportation cost of the goods by the weight of the goods.

27. The method of claim 24, wherein the ranking rule comprises the following ranks:
rank 4: selecting the goods with the maximal density;
rank 5: selecting the goods with the maximal length;
rank 6: selecting the goods with the maximal width; and
rank 7: selecting the goods with the maximal height.

28. The method of claim 27, in which the order from rank 4 to rank 7 is unrestricted.

29. A computer readable medium which is used to record a method of arranging goods, which method being used for the goods transportation and to instruct the computer performing the steps as follow:
(a) inputting related information of the goods, which should be put into a storage space, in which the related information at least comprises the size of the goods;
(b) determining a placing priority of the goods in accordance with a ranking rule;
(c) selecting goods of the first priority for placing into the storage space;
(d) placing the selected goods into an available space;
(e) searching and combining available spaces in the storage space;
(f) determining whether goods of next priority exist or not, if it is affirmative, proceeding to the step (g); otherwise, proceeding to the step (i)
(g) treating the goods of the next priority as the selected goods at the moment;
(h) inspecting whether the available space of the storage space is larger than the size of the selected goods or not; if it is affirmative, proceeding to step (c); otherwise, proceeding to step (f); and
(i) outputting the result of the goods arrangement.

30. The method of claim 29, wherein the ranking rule of the step (b) needs to be performed in the following order:
rank 1: selecting the goods with the highest cost effective benefit;
rank 2: selecting the goods with the largest base dimensions; and
rank 3: selecting the goods with the largest base area.

31. The method of claim 30, in which the cost effective benefit of the goods in rank 1 is obtained from dividing the transportation cost of the goods by the volume of the goods.

32. The method of claim 30, in which the cost effective benefit of the goods in rank 1 is obtained from dividing the transportation cost of the goods by the weight of the goods.

33. The method of claim 30, wherein the ranking rule of the step (b) comprises:
rank 4: selecting the goods with the maximal density;
rank 5: selecting the goods with the maximal length;
rank 6: selecting the goods with the maximal width; and
rank 7: selecting the goods with the maximal height.

34. The method of claim 33, in which the order from rank 4 to rank 7 is unrestricted.

35. The method of claim 29, wherein the selected goods of step (d) is stacking for building a vertical column; if the space on top of the vertical column can not accommodate the goods of the next priority, the goods of the next priority will be placed in the space adjacent to the vertical column for building another vertical column; accordingly, a lateral wall or a longitudinal wall is built.
